(19) United States
(12) Patent Application Publication
(10) Pub. No.: US 2008/0092859 A1
(43) Pub. Date: Apr. 24, 2008

(54) Vegetable oil fuel system for diesel engines

(75) Inventor: Walter David Little III, Yorktown Heights, NY (US)

Correspondence Address: Paul D. Greely;Ohlandt, Greeley, Ruggiero & Perle, L.L.P., One Landmark Square, 10th Floor, Stamford, CT, 06901-2682, US

(73) Assignee: V.O. Tech LLC

(21) Appl. No.: 11/818,729

(22) Filed: Jun. 15, 2007

Related U.S. Application Data
(60) Provisional application No. 60/813,783, filed on Jun. 15, 2006.

(51) Int. Cl. F02M 31/02

(52) U.S. Cl. 123/557; 123/196 A

(57) ABSTRACT

The disclosure is an “all-in-one” fuel device for a diesel engine using vegetable oil as fuel. The device prevents or overcomes the problems of insufficient fuel temperature and fuel filter waxing associated with previous devices. The fuel device incorporates a vegetable oil fuel filter, built-in valve assembly and heat exchangers using a combination of electric heaters and coolant from the engine's cooling system. The fuel device is disclosed as part of diesel engine systems operating with vegetable oil, biodiesel, and conventional petroleum-based diesel fuels. Also disclosed is a method of using the disclosure for large and small diesel engine systems in automobiles, trucks, boats, agricultural machines, chain saws, mopeds, jet skis, locomotives, ships and electrical power-generating facilities.

### CROSS-REFERENCE TO RELATED APPLICATIONS

The present application is claiming priority of U.S. Provisional Patent Application Ser. No. 60/813,783, filed on Jun. 15, 2006, the content of which is herein incorporated by reference.

### BACKGROUND OF THE INVENTION

1. Field of Invention

The disclosure relates generally to a fuel system assembly to use vegetable oil as fuel for diesel engines. More particularly, the disclosure relates to an “all-in-one” fuel system assembly incorporating a vegetable oil fuel filter, built-in valve assembly, and heat exchange using an electric heater and/or the engine's coolant system, to prevent or overcome problems of insufficient fuel temperature and filter waxing commonly associated with other existing systems using vegetable oil as diesel fuel. Also disclosed is a method of using the present disclosure as part of diesel engine fuel systems to operate passenger vehicles, boats, tools, and agricultural machines.

2. Description of the Related Art

Diesel engines will operate using a variety of types of fuels from different sources, including conventional petroleum products, vegetable oils, biodiesels, synthetic chemicals, and combinations of these types of fuels.

Vegetable oils from a variety of sources have been used as fuels for diesel engines for more than one hundred years. Rudolph Diesel was popularly reported to have used peanut oil as fuel when demonstrating his diesel engine at the 1900 Paris Exposition. The U.S. Department of Energy (DOE) Biomass Program continues to develop and promote technologies for conversion of plant-derived material (biomass) to fuels, chemicals and power, to reduce dependence on foreign oil and foster growth of renewable energy resources.

Vegetable oil suitable for use as fuel for diesel engines may be harvested from several types of oil feedstocks, such as soybean oil, rapeseed (canola) oil, corn oil, sesame oil, and cottonseed oil, particularly those having high cetane ratings, long induction periods, relatively low viscosity, low cloud points and low pour points. Other acceptable vegetable oil feedstocks within the scope of this disclosure include, but are not necessarily limited to, sunflower oil, peanut oil, linseed oil, safflower oil, palm oil, jatropha (pourghere) oil, and coconut oil.

Vegetable oil need not be raw or unused to be suitable as fuel for diesel engines. Used or recycled vegetable oils, such as oils previously used to prepare foods (WVO, or waste vegetable oil) can be serviceable as potential fuel for diesel engines. However, used and recycled vegetable oils may contain dissolved animal fats or fish oils that would not be present in unused or new vegetable oils obtained from oil feedstocks. As a result, recycled oils generally require more stringent filtering and pre-heating in order to be used as fuel for diesel engines.

Vegetable oils that are to be used as fuel for diesel engines are commonly divided into two types. The first type is called Straight Vegetable Oil (SVO) or Pure Plant Oil (PPO), and is typically new oil that is fresh and uncooked. The second type is Waste Vegetable Oil (WVO), which is used cooking oil, grease, and/or fryer oil that may include both vegetable oils and animal fats or fish oils from cooking. A combination of SVO and WVO, or a combination of SVO and WVO with traditional diesel fuel, can also be used as fuel in diesel engines.

One of the main obstacles to overcome when using vegetable oil as fuel for diesel engines is that vegetable oil is generally much more viscous (i.e., thicker) than conventional petroleum-based diesel fuel. Depending on the source, vegetable oils may be as much as eleven to seventeen times thicker than petroleum-based diesel fuel. If the fuel is too viscous, it cannot be properly atomized and will not combust as completely as traditional diesel fuel will in the engine chambers, leading to poor engine performance and, eventually, fouling or “coking up” of the fuel injectors and fuel pump damage. One approach addressing the problem of high fuel viscosity has been to blend vegetable oil with conventional petroleum-based diesel fuel in various proportions, such as the commercially-available diesel blend B20 (20% vegetable oil and 80% conventional petroleum-based diesel fuel). However, this approach solves only part of the problem, as the goals for use of vegetable oil as diesel fuel not only is clear passage through the fuel lines and injectors but also efficient burning of the fuel when it reaches the combustion chamber, for improved engine performance and reduced emissions of harmful end products.

Also, at cold temperatures, vegetable oils tend to crystallize, forming solid wax crystals that can block or clog the fuel filters. Diesel engines operating at high pressures, in particular, require clean fuel because even small foreign particles or water in the fuel can cause wear on the injectors, either internally in the injector valves or at the spray nozzle tip. Dirt or water flowing at high pressure through the injectors may etch or cut into the injector surfaces. At low temperatures, some types of vegetable oils are inherently more prone than others to form wax crystals that can clog fuel filters, and WVO (i.e., used or recycled vegetable oils) are more likely to crystallize at low temperatures because of dissolved animal fats from cooking.

One approach that has been used in prior fuel systems to address the problem of clogged filters from wax crystal formation, especially at cold temperatures, has simply been to exchange a 10-micron (or smaller) fuel filter with a fuel filter having a larger filter pore size, such as a 30-micron filter, so that the wax crystals pass right through the fuel filter, presumably to melt in the fuel injection pump before damaging or clogging the pump and/or the fuel injectors. However, using fuel filters having larger filter pore sizes to avoid clogging has been an unsatisfactory approach, particularly in view of the damage that wax crystals and other particles can cause to fuel injectors in diesel engines.

Vegetable oils are generally better-tolerated as fuel in diesel engines having Indirect Diesel Injection (IDI) (where the vegetable oil is injected into a pre-chamber or swirl chamber before passing through to the combustion chamber) than in diesel engines having Direct Injection (DI), such as Turbo-Direct Injection (TDI), Common-Rail Direct Injection (CDI), or “Pumpe Duse” Injectors (PDI). For this reason, fuel technologies for vegetable oils that were used for older IDI-type diesel engines (such as in 1980's-era Mercedes or Volkswagen engines) may not be tolerated for vehicles using the newer DI-type engines.

In addition, mechanical fuel injection systems tend to be more tolerant of vegetable oil as diesel fuel than computerized fuel injection systems.

Vegetable oils contain fatty acids having unsaturated carbon-carbon bonds, which can polymerize in a fuel system to form engine deposits. The Iodine Value (IV) or Iodine Number is a measure of the average amount of unsaturation present in fats and oils, and is expressed as the number of centigrams of iodine absorbed per gram of sample (% iodine absorbed). A high Iodine Value correlates with a high degree of unsaturation. Vegetable oils having high Iodine Values can be pre-treated to reduce unsaturation before use as diesel fuel.

In practice, vehicles with diesel engines equipped to use vegetable oils as fuel often use a “two-tank” apparatus, where one fuel tank holds the vegetable oil fuel (this tank may also hold a combination of vegetable oil and conventional diesel fuel) and a second fuel tank holds conventional petroleum-based diesel fuel (or, alternatively, biodiesel fuel). When the engine is cold-started, the diesel engines use fuel from the petroleum tank, and operate on that fuel for sufficient time until the vegetable oil from the second system is pre-heated, using heat exchangers such as an electrical heater and/or the engine's own cooling system. When the vegetable oil reaches the temperature of about 70-80° C. (160-180° F.), the fuel source for the diesel engine is switched to vegetable oil. Then, moments before the diesel engine is to be turned off, the fuel source is switched back to the conventional petroleum-based fuel to purge the fuel lines of vegetable oil and to clear the fuel filters, in preparation for the next start-up.

Alternatively, “single-tank” fuel systems using vegetable oil as fuel are also presently available. Single-tank systems use specially-made injector nozzles, increased injection pressure, and stronger glow-plugs, in addition to fuel pre-heating.

Another diesel fuel that is derived from vegetable oil is “biodiesel,” which is vegetable oil or animal fat that has been chemically transformed by reacting the oil or fat with various alcohols, producing a product with reduced viscosity that can be directly substituted as neat fuel or as an oxygenate additive for the diesel engine. Examples of chemical processes used to produce biodiesel fuels include transesterification, pyrolysis, micro-emulsion, or thermal depolymerization. Transesterification of a vegetable oil intended for use as diesel fuel, for example, is accomplished by reacting the vegetable oil with an alcohol in the presence of a catalyst, thereby neutralizing the free fatty acids and creating an alcohol ester, which then possesses the proper viscosity to be used as diesel fuel after further processing to remove byproducts (such as glycerin) and impurities. Generally, the esters produced as biodiesels have lower Iodine Values than their corresponding free fatty acids. As an example, soybean oil may be subjected to transesterification by reacting the soybean oil with a solution of methanol (CH₃OH) and sodium hydroxide (NaOH), thereby yielding the biodiesel product (in the form of a methyl ester) and the reaction byproduct glycerin, which then must be separated from the biodiesel product, usually by allowing the solution to settle in a settling tank.

Chemical transformation of vegetable oil into biodiesel fuels has the drawback that it is currently expensive, and that the chemical reaction produces byproducts, such as glycerin, that must be removed before the biodiesel product can be used as fuel. In addition, the biodiesel products often have detergent characteristics that can loosen debris in the fuel tanks and fuel lines, which can clog fuel lines and fuel filters. Also, many biodiesel products have the disadvantage of higher NOₓ exhaust emissions (e.g., nitrous oxide and nitric oxide), as compared to conventional diesel fuel, requiring additives to reduce NOₓ emissions to be blended with the biodiesel product to achieve satisfactory NOₓ exhaust levels.

Vegetable oil used as fuel for diesel engines should be heated, and maintained at elevated temperatures, at all points outside of the fuel tank, to reduce viscosity and to pre-heat the vegetable oil to the temperature necessary for efficient injection and combustion in the cylinder. Heating the vegetable oil for use as diesel fuel can be accomplished in any of several ways described below.

Even when heated to 70-80° C. (160-180° F.), vegetable oils are generally still more viscous than conventional petroleum-based diesel fuel. For instance, rapeseed (canola) oil is approximately six times more viscous at 70-80° C. as compared with conventional petroleum-based diesel fuel. One study investigating the burning characteristics of atomized vegetable oil droplets under high pressures and high temperature conditions showed that rapeseed oil attained the same viscosity and performance in atomization tests as conventional petroleum-based diesel oil only at temperatures of approximately 150° C. (302° F.), which is nearly double the temperature generally used for vegetable oil fuel systems described above. See Final Report of the Advanced Combustion Research for Energy from Vegetable Oils (ACREVO) (CPL Press, 1998). According to another study, when vegetable oil is heated to 88° C. (190° F.), its viscosity approaches that of diesel fuel at 18° C. (64° F.). See Samuel Jones, et al., “Used Vegetable Oil Fuel Blend Comparisons Using Injector Coking in a DI Diesel Engine,” ASAE Paper No. 01-6051, presented at the 2001 ASAE Annual International Meeting, Sacramento, Calif., USA (Jul. 30-Aug. 1, 2001).

Ideally, vegetable oil intended for use as diesel fuel should be cleansed of any foreign particles, and have most or all trapped water removed, before the vegetable oil is fed into the combustion chamber by the fuel injectors. Foreign particles can clog the fuel filter screens, and smaller particles that pass through the fuel filters can clog or coke up the injectors. Pre-filtration of the SVO and WVO is essential to remove as many of the particles as practical through the use of commercially-available micron-rated filters.

Water contained in the vegetable oil can corrode or rust the injectors and the inner parts of the injection pump, such as the cam rollers and cam plate. Also, water that is injected (sprayed) along with the vegetable oil into the engine cylinder can lead to incomplete combustion and poor engine performance. There are commercially-available fuel/water separators to remove water from contaminated vegetable oil, but these may not remove all of the water, particularly if the water is suspended or emulsified in the vegetable oil. One commonly-accepted method that has been used to separate water from vegetable oil is to warm the vegetable oil to a temperature typically about 120° F.-130° F. for a period of 8 to 10 hours. Higher temperatures expedite the tendency of water to separate from the vegetable oil. Once the water separates from the vegetable oil in the tank, the water is drained out of the tank. An alternative method is to heat the vegetable oil to a sufficient temperature such that any water in the oil is boiled off.

Some fuel filters or processors simply filter out foreign particles from the vegetable oil, and do not separate water from the oil. Other types of fuel processors perform both functions and filter out foreign particles and separate water from the vegetable oil, using centrifugal force to separate the more-dense water from the less-dense vegetable oil.

Prior configurations of fuel systems using vegetable oil as diesel fuel have the disadvantages that none have demonstrated an efficient configuration to prevent or overcome the problems of insufficient vegetable oil heating, fuel filter waxing, and injector coking and wear because the vegetable oil is not properly flushed from the fuel filters. The prior fuel system configurations do not typically have a means to heat the vegetable oil to sufficient operating temperature. The prior fuel system configurations also do not completely back-flush the vegetable oil from the filter, and the prior configurations typically separated the valves from the filter. This separation requires the use of lengthy sections of hoses to carry fuel, during which time the vegetable oil inside the hoses undergoes further heat loss. The present disclosure overcomes the disadvantage of insufficient fuel heating found in prior fuel systems by employing an “all-in-one” design, described in detail below, which provides ample heat to the vegetable oil and to the fuel filters by a combination of electric heaters and the engine's own coolant system, while minimizing heat loss in fuel lines and filter by reducing the need for lengthy fuel hoses.

The disadvantage of fuel filter waxing in prior fuel system configurations is prevented or overcome in the present disclosure by a heated fuel filter that is part of the “all-in-one” fuel system assembly, providing sufficient heat and a means of back-flushing the fuel filter to clear vegetable oil out of the fuel filter without back-flushing debris out of the filter element.

Another disadvantage of prior configurations of vegetable oil fuel systems was that a relatively large amount of water was often still contained in the vegetable oil when the fuel reached the fuel injectors and combustion chamber. This disadvantage is largely prevented or overcome in the present disclosure by providing sufficient heat to the filter housing to allow water to separate and providing a means to drain off any excess water that may accumulate within the filter. Prior vegetable oil fuel systems do not adequately address these issues.

The disadvantage of solid contaminants contained in the vegetable oil fuel is prevented by a specially designed stainless steel fuel filter inside of the “all-in-one” fuel system assembly.

### SUMMARY OF THE INVENTION

The disclosure is a fuel device or fuel system assembly to use vegetable oil as fuel for a diesel engine. The fuel system assembly is an “all-in-one” device incorporating a vegetable oil fuel filter, built-in valve assembly, and heat exchanger using a combination of electric heat and/or the engine's coolant system, to prevent or overcome problems of insufficient fuel temperature and filter waxing associated with previous devices associated with vegetable oil used as diesel fuel. In addition, diesel fuel systems which incorporate the fuel system assembly of the present disclosure to operate vehicles, boats, tools, and agricultural equipment using vegetable oil as fuel are disclosed. Also disclosed are methods of using the fuel system assembly device to provide power to a diesel engine.

A unique aspect of the disclosure is its “all-in-one” design that overcomes the problem of insufficient fuel temperature, which has caused difficulties for prior efforts to use vegetable oil as diesel fuel. The problem is overcome by using a combination of electrical heat and/or the coolant system (typically from the engine's cooling system) to supply ample heat to the vegetable oil and to the filter itself, and by the “all-in-one” coolant jacketed design.

Another unique aspect of this system is the hollowed double wall design of the filter housing. With this unique design, the hot engine coolant surrounds the vegetable oil and the filter, which forces the vegetable oil to approach or reach engine coolant temperature. No currently available products use this design and no currently available products will raise vegetable oil temperatures faster or to the temperatures achieved by this system.

The present disclosure also has a specially-designed fuel filter that is inside of the “all-in-one” fuel system assembly. The fuel filter may be made of a material such as stainless steel, paper, or other filter media, and/or any combinations thereof.

The problem of filter waxing is prevented or minimized by use of a heated fuel filter and by back-flushing the fuel filter to clear vegetable oil out of the filter chamber without back-flushing debris out of the filter element.

The fuel filter in this disclosure can be placed in a coolant bath which surrounds the filter element. In addition, the filter element is seated on a Positive Temperature Coefficient (PTC)-type self-regulating electric heater which was designed for heating vegetable oil for use as diesel fuel.

Heat retention for the vegetable oil is maximized as a result of the fact that the filter assembly, valves and manifold are all in a single unit (which may, but does not necessarily have to be, insulated), thereby reducing the use of hoses (which lose heat) carrying the vegetable oil from the fuel tank to the combustion area of the engine. Insulation may be added to promote maximum heat retention.

The present disclosure has a heated fuel filter that is part of the “all-in-one” fuel system assembly, providing sufficient heat and a means of back-flushing the fuel filter to clear vegetable oil out of the fuel filter without back-flushing debris out of the filter element. This is accomplished by keeping Valve A (described below) closed, thereby allowing diesel fuel to flow to the engine, while the return on Valve B remains open so that diesel fuel can flow into the filter housing chamber from the engine return. Diesel fuel will fill the filter housing and flow back to the vegetable oil tank, thereby pushing diesel fuel just around the filter instead of through the fuel filter.

The “all-in-one” fuel device or fuel system assembly also has a means to remove water from the vegetable oil by providing sufficient heat to the filter housing, which permits the water to separate from the vegetable oil and providing a means to drain off any excess water that may accumulate within the filter and/or filter housing. As water is heavier than most vegetable oils used in this system, water has a natural tendency to separate from the vegetable oil and to sink below it. Higher temperatures expedite this natural tendency. As a result, any water that separates during this process can be drained off using a built-in drain.

### BRIEF DESCRIPTION OF THE DRAWINGS

FIG. 1 is a front perspective view of a fuel system assembly and a manifold for a diesel engine using vegetable oil as fuel, as assembled.

FIG. 2 is an exploded front perspective view of the fuel system assembly and the manifold shown in FIG. 1.

FIG. 3 is an end view of the fuel system assembly in FIG. 1.

FIG. 4 is a top side view of the fuel system assembly in FIG. 1. Axis A-A drawn through the center of FIG. 4 indicates the plane of the sectional view for FIG. 5.

FIG. 5 is a front sectional view of the fuel system assembly in FIG. 1 along plane A-A shown in FIG. 4.

FIG. 6 is an end view of the fuel system assembly body.

FIG. 7 a left side view of the fuel system assembly body shown in FIG. 6.

FIG. 8 is a right side view of the fuel system assembly body shown in FIG. 6.

FIG. 9 is a plan view of the external section of the fuel system assembly body shown in FIG. 6.

FIG. 10 is a three-dimensional front perspective view of the fuel system assembly body.

FIG. 11 is a bottom perspective view of the cap.

FIG. 12 is a front side view of the cap shown in FIG. 11.

FIG. 13 is a plan view of the cap shown in FIG. 11.

FIG. 14 is a right side view of the cap shown in FIG. 11.

FIG. 14A is a plan view of the cap shown in FIG. 11.

FIG. 14B is a sectional view of the cap shown in FIG. 11 along the plane of the axis drawn in FIG. 14A. This cap can be made of aluminum, high temperature plastic, or other material.

FIG. 14C is a sectional view of the cap shown in FIG. 11 along the circular section drawn in FIG. 14B.

FIG. 15 is a front perspective view of a filter holder.

FIG. 16 is a plan view of the filter holder shown in FIG. 15.

FIG. 17 is a front side view of the filter holder shown in FIG. 15.

FIG. 18 is a right side view of the filter holder shown in FIG. 15.

FIG. 18A is a front perspective view of the filter tube.

FIG. 18B is a left side sectional view of the filter tube shown in FIG. 18A.

FIG. 18C is an end view of the filter tube shown in FIG. 18A.

FIG. 18D is a right side sectional view of the filter tube shown in FIG. 18A.

FIG. 19 is a front perspective view of the fuel filter.

FIG. 20 is a plan view of the fuel filter shown in FIG. 19.

FIG. 21 is a top side view of the fuel filter shown in FIG. 19.

FIG. 22 is a right side view of the fuel filter shown in FIG. 19.

FIG. 23 is a front perspective view of a donut-shaped heater which is a PTC (self-regulating) heater used in the fuel system assembly.

FIG. 24 is a plan view of the heater shown in FIG. 23.

FIG. 25 is a right side view of the heater shown in FIG. 23.

FIG. 26 is a plan view of the manifold shown in FIG. 1 and FIG. 2.

FIG. 27 is a left side view of the manifold shown in FIG. 1 and FIG. 2.

FIG. 28 is a rear side view of the manifold shown in FIG. 1 and FIG. 2.

FIG. 29 is a plan view of the manifold in FIG. 1 and FIG. 2 showing axis A-A indicating the plane used for the sectional view in FIG. 30.

FIG. 30 is a right side sectional view along plane A-A of the manifold shown in FIG. 1 and FIG. 2.

FIG. 31 is a left side view of the manifold shown in FIG. 1 and FIG. 2.

FIG. 32 is a front side view of the manifold shown in FIG. 1 and FIG. 2.

FIG. 33 is a front perspective view of a water sensor and drain valve.

FIG. 34 is a front perspective view of a bleed valve.

FIG. 34A is a front perspective view of a bleed valve.

FIG. 35 is a diagram of a Valve used in the present disclosure.

FIG. 36 is a front perspective view of a Sight Glass or Sight Window.

FIG. 37 is a schematic diagram of the operation of the present disclosure.

FIG. 38 is a diagram of the fuel system assembly, shown in a sectional view.

FIG. 39 is a front perspective view of the fuel system assembly body.

FIG. 39A is a front perspective view of the fuel system assembly body shown in FIG. 39 with labeled components.

FIG. 40 is a left side view of the manifold.

FIG. 40A is the manifold shown in FIG. 40 with labeled components.

FIG. 41 is a right side view of the manifold.

FIG. 41A is the manifold shown in FIG. 41 with labeled components.

### DETAILED DESCRIPTION OF THE INVENTION

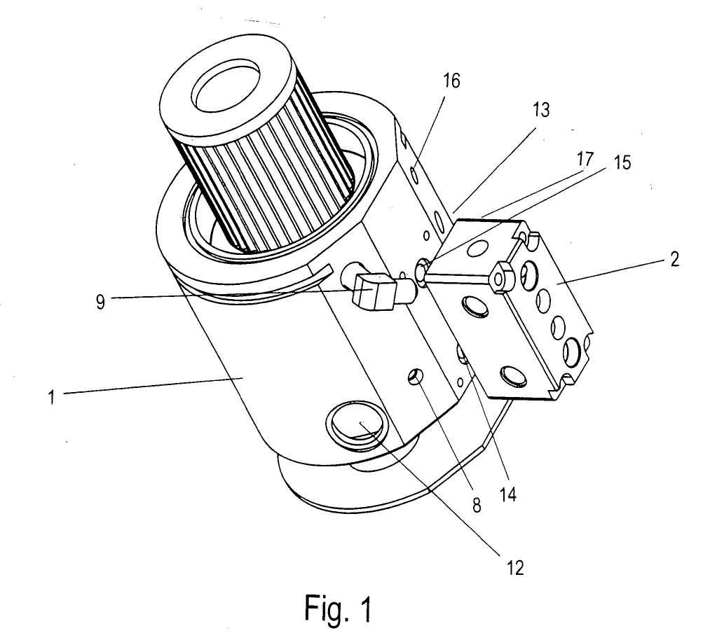

FIG. 1 illustrates a fuel system assembly 1 of the present disclosure (assembled), to use vegetable oil as fuel for a diesel engine, and a manifold 2. Also shown in FIG. 1 are: coolant port (in) 12 and coolant port (out) 13; “Valve A” 14 (filtered oil to engine) and “Valve B” 15 (return); bleed off valve 16; and port 17 for vegetable oil coming in from the vegetable oil fuel tank.

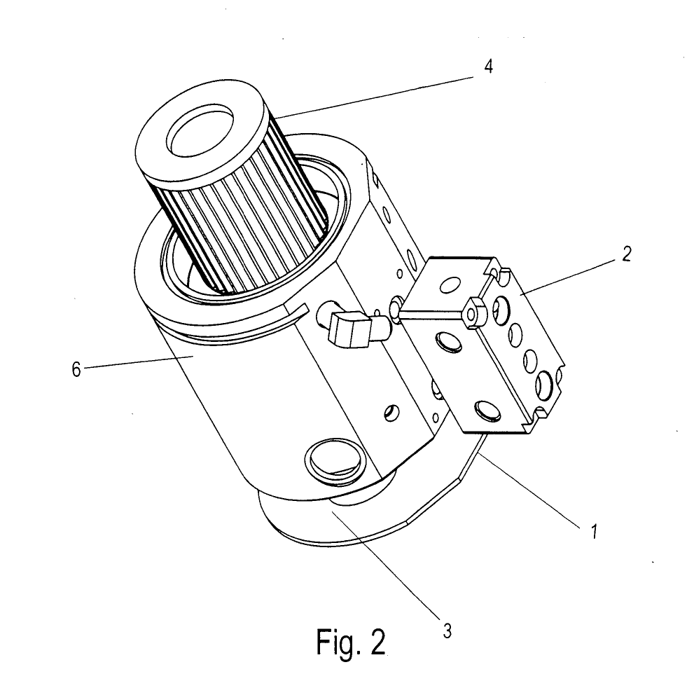

FIG. 2 shows the fuel system assembly 1 in a front perspective exploded view, illustrating the fuel system assembly 1, manifold 2, fuel system assembly body (or cartridge) 3, fuel filter cartridge 4, removable cap (or lid) 5, and mounting slot 6. The manifold 2 is designed to be either affixed to the fuel system assembly body 3, or to be mounted separately from the fuel system assembly body due to close tolerances inside an engine compartment.

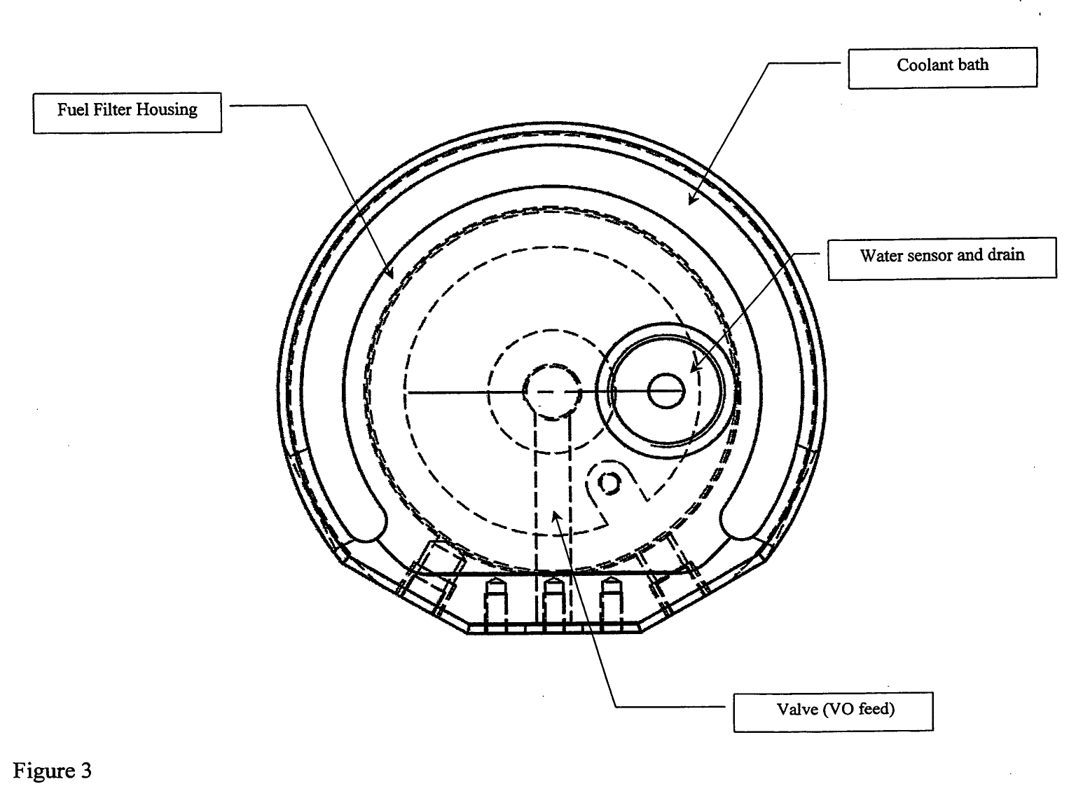

An end view of the fuel system assembly 1 is illustrated in FIG. 3. Also illustrated in FIG. 3 are the valve for the vegetable oil (VO) feed, and ports for the water sensor 18 and drain 19, the coolant bath 20, and the fuel filter housing 21.

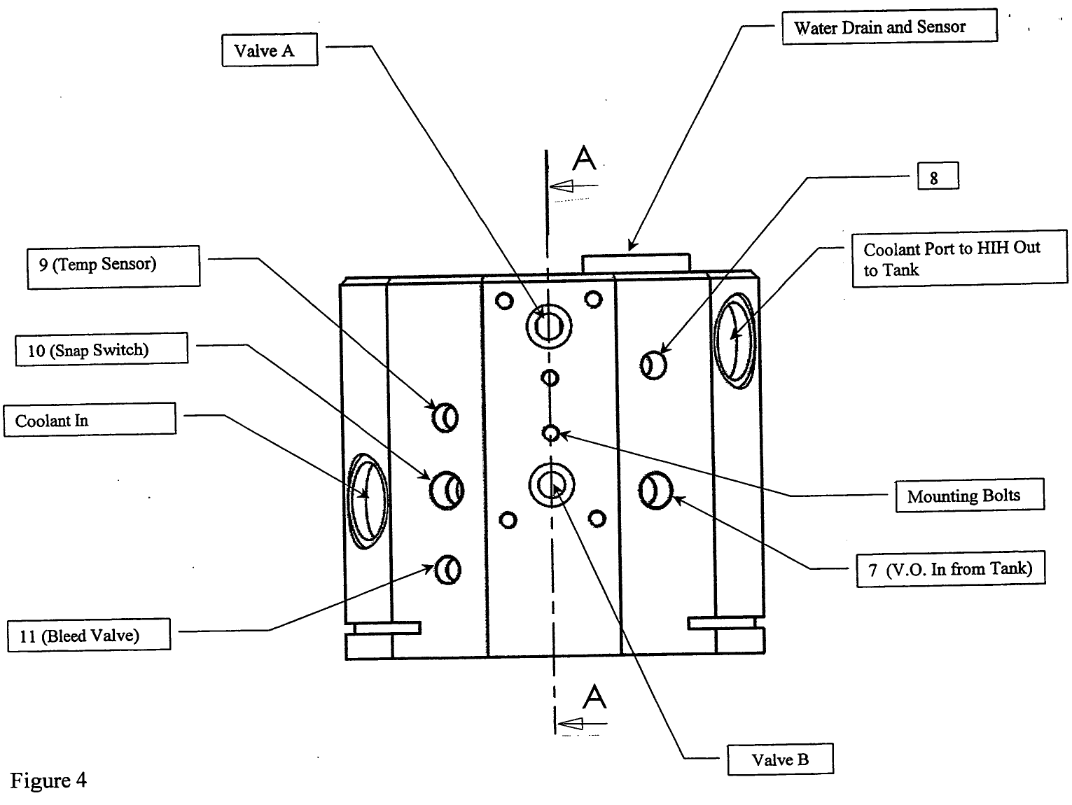

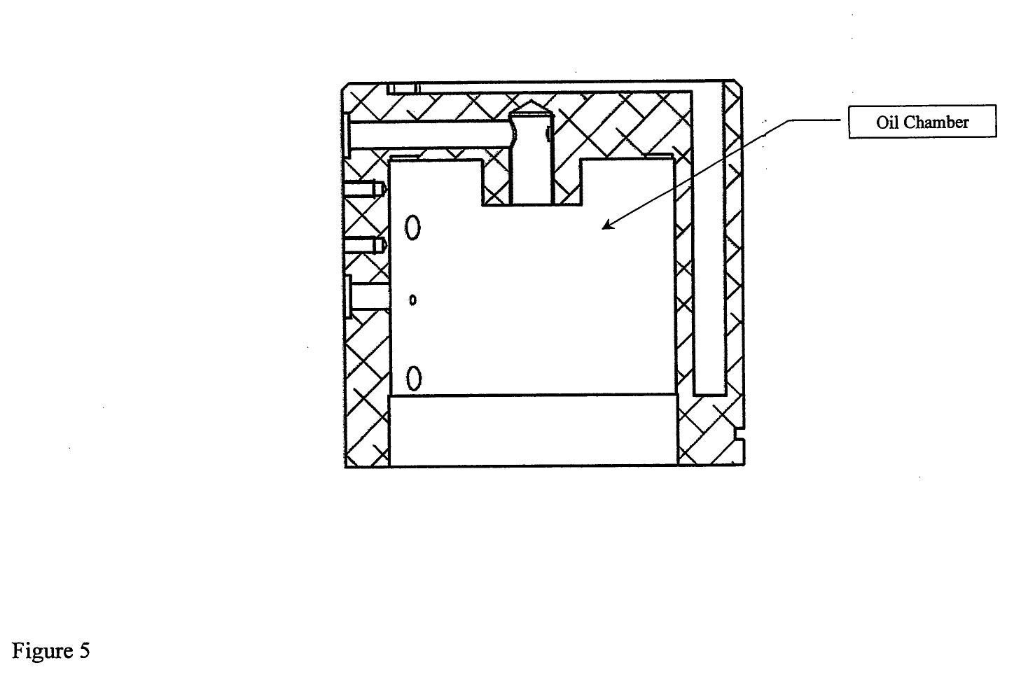

FIG. 4 is a top side view of the fuel system assembly body 3. Axis A-A drawn through the center of FIG. 4 indicates the sectional view used for FIG. 5. The ports for Valve A and for Valve B are illustrated in FIG. 4. FIG. 4 also shows the port 7 for the Vegetable Oil (VO) Intake from the fuel tank. The port for water sensor and drain valve is shown on FIG. 4. Coolant ports leading in to, and leading out from, the fuel system assembly body 3 are also shown on FIG. 4. The Hose-In-Hose (HIH) heat exchange system enters and leaves the fuel system assembly body 3 through these two ports, labeled Coolant In and Coolant Out. Also illustrated on the same flat surface of the fuel system assembly body 3 is a heater wire port 8. Port 9 for the temperature sensor, port 10 for a snap switch temperature sensor, and port 11 for a bleed valve are also labeled on FIG. 4. The location of holes 22 for mounting bolts connecting the manifold 2 to the fuel system assembly body 3 are also labeled on FIG. 4.

FIG. 5 is a front sectional view of the fuel system assembly body 3 along plane A-A shown in FIG. 4. The main oil chamber 23 is illustrated in FIG. 5.

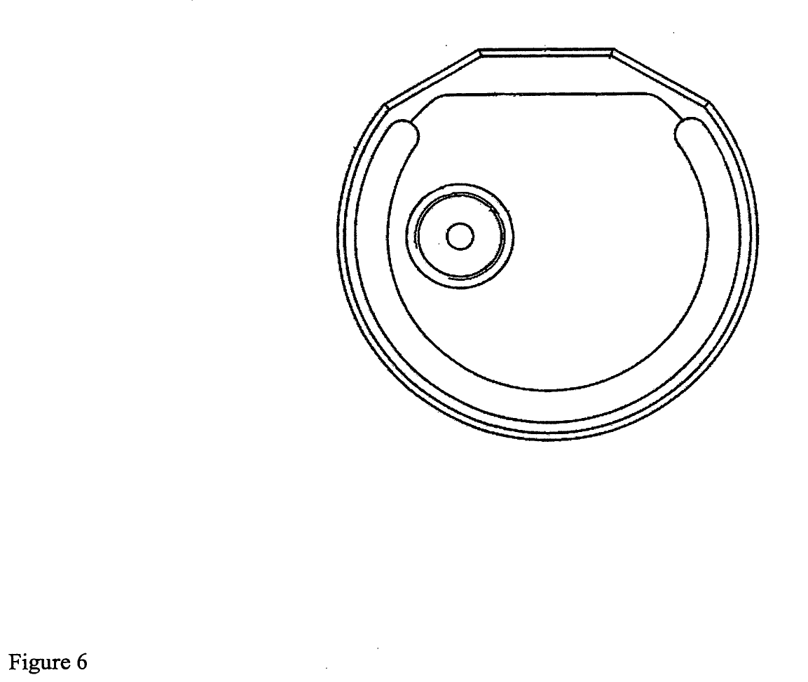

FIG. 6 illustrates a simplified end view of the fuel system assembly body 3, showing the relative locations of the port for the water sensor 18 and drain valve 19, and for the Coolant Bath 20.

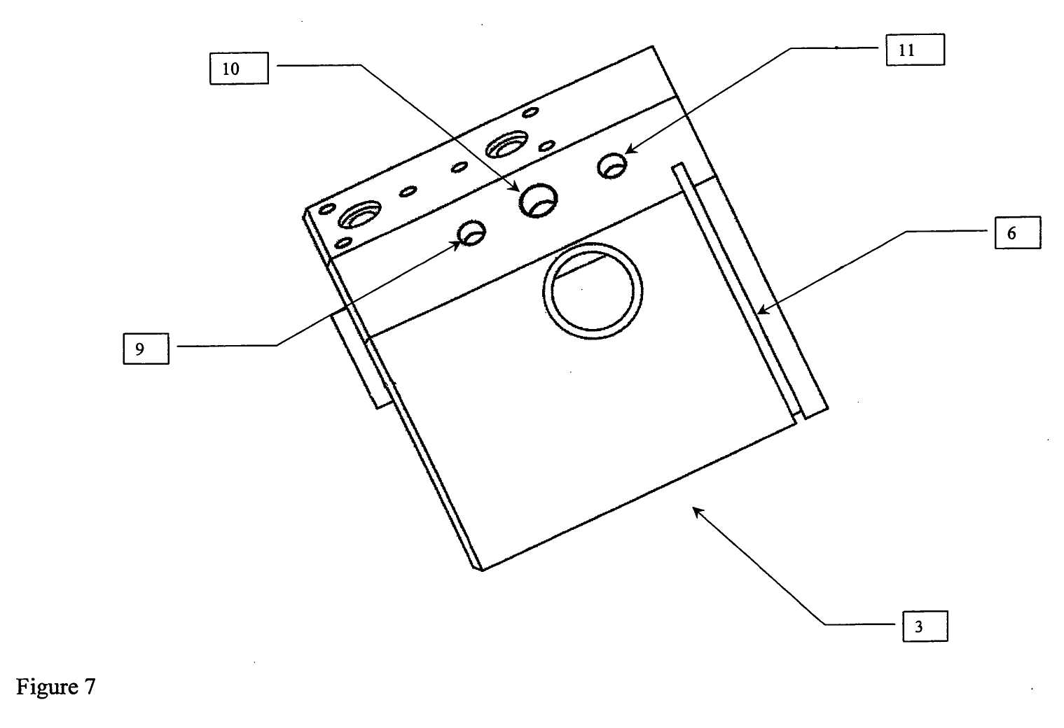

FIG. 7 is a left side view of the fuel system assembly body 3, illustrating a mounting slot 6, and three access ports, specifically the temperature sensor port 9, snap switch thermometer port 10, and bleeder valve port 11. Also illustrated is the port labeled Coolant In.

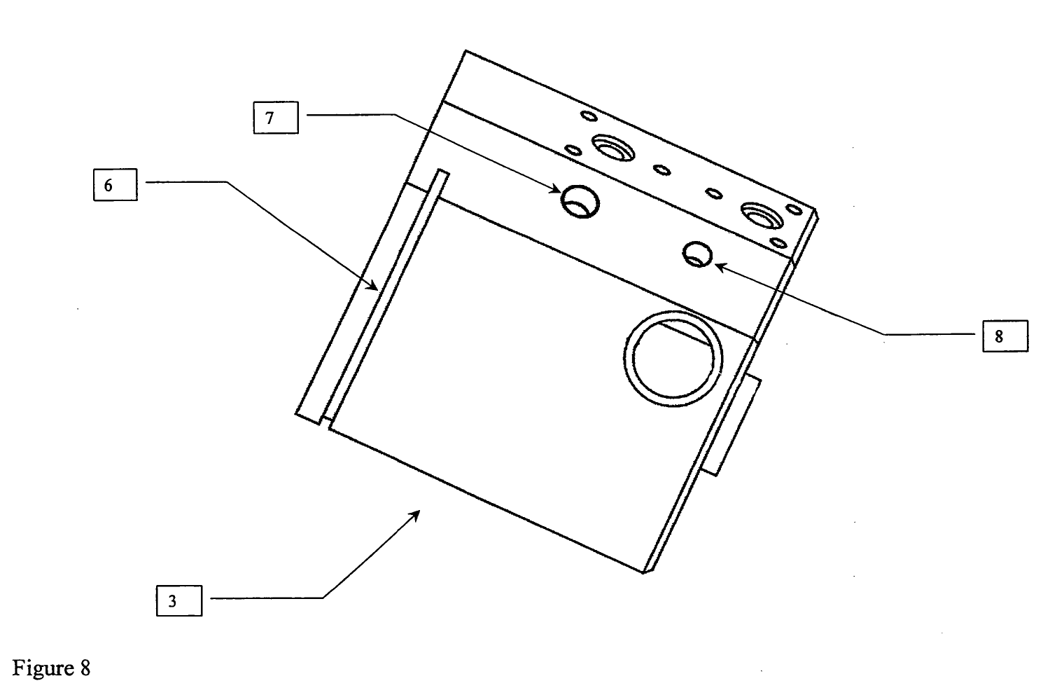

FIG. 8 is a right side view of the fuel system assembly body 3, illustrating mounting slot 6, and two access ports: the port for the vegetable oil intake 7 from the vegetable oil fuel tank, and the heater wire port 8. Also illustrated in FIG. 8 is the Coolant Out port where the Hose-In-Hose (HIH) heat exchange device leaves the fuel system assembly body 3.

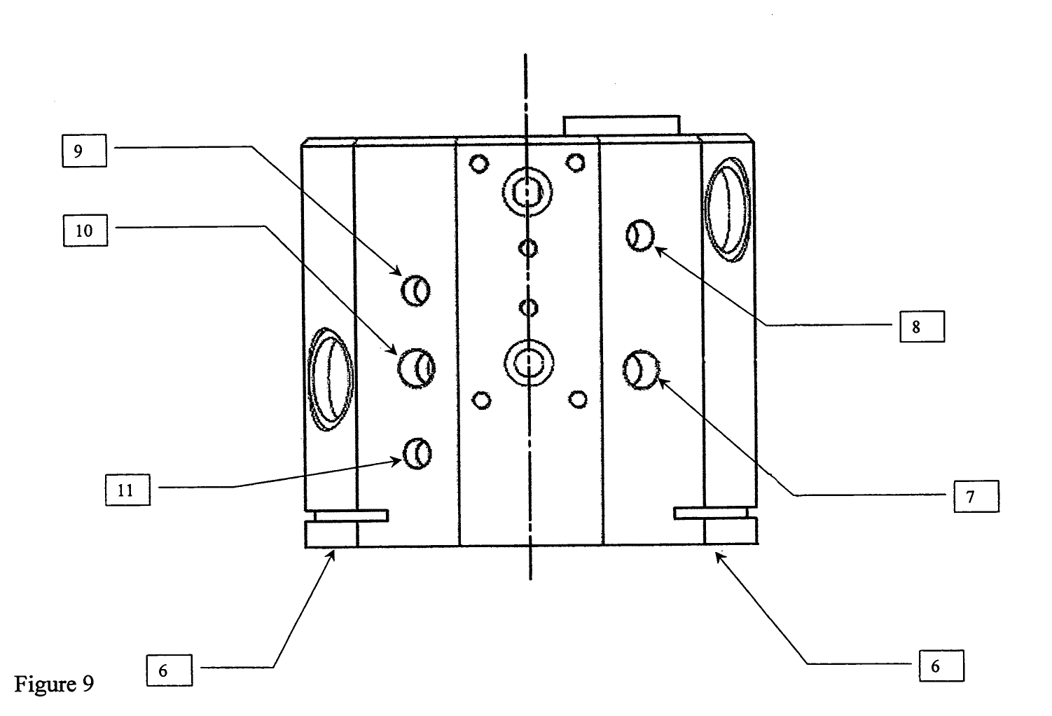

FIG. 9, which is a plan view of the fuel system assembly body 3, illustrates mounting slot 6, and nine access ports, specifically the port for the vegetable oil intake 7 from the vegetable oil fuel tank, the heater wire port 8, the temperature sensor port 9, the snap switch thermometer port 10, and the bleeder valve port 11. Also shown are the Coolant In and Coolant Out ports, as well as the Valve A and Valve B ports.

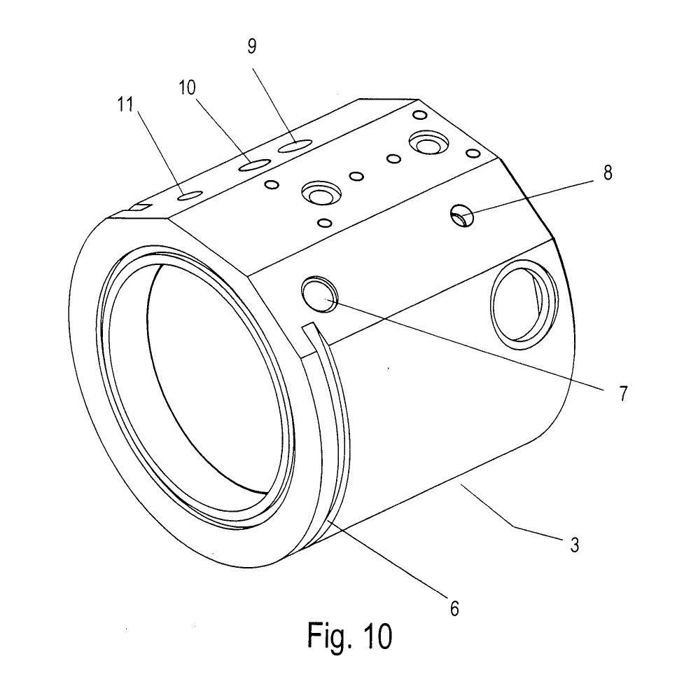

FIG. 10, which is a three-dimensional front perspective view of the fuel system assembly body 3, illustrates the mounting slot 6, and eight of the external access ports, specifically the port for the vegetable oil intake 7 from the vegetable oil fuel tank, the heater wire port 8, the temperature sensor port 9, the snap switch thermometer port 10, and the bleeder valve port 11. Also shown is the port 13 for Coolant Out, and the ports for Valve A 14 and Valve B 15.

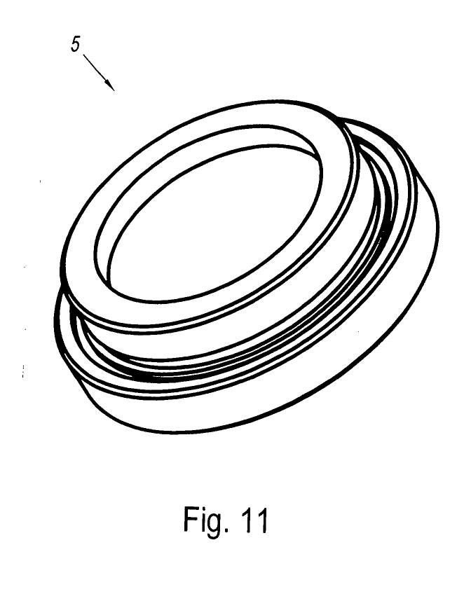

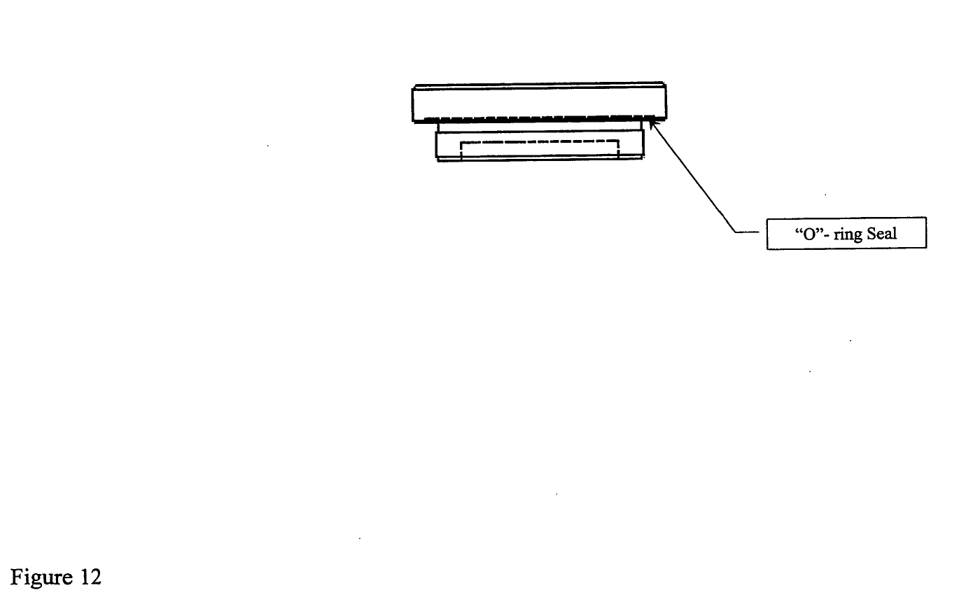

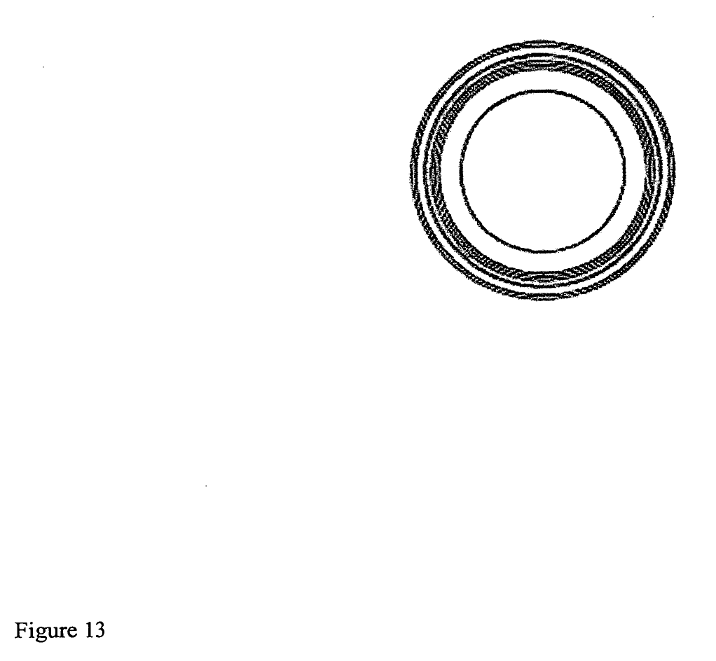

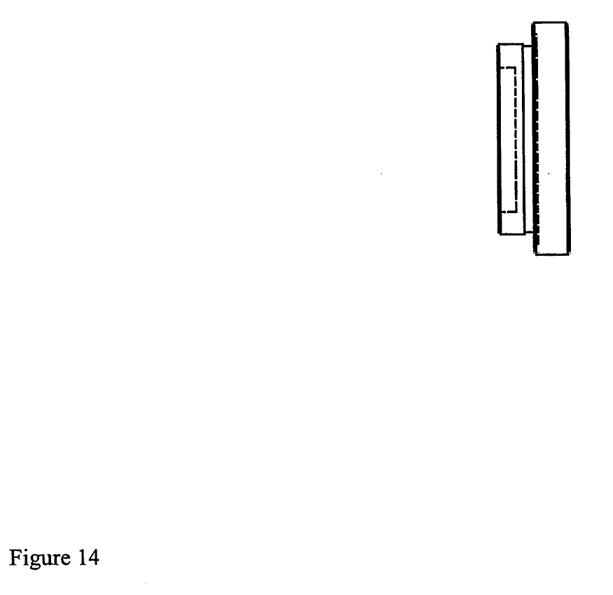

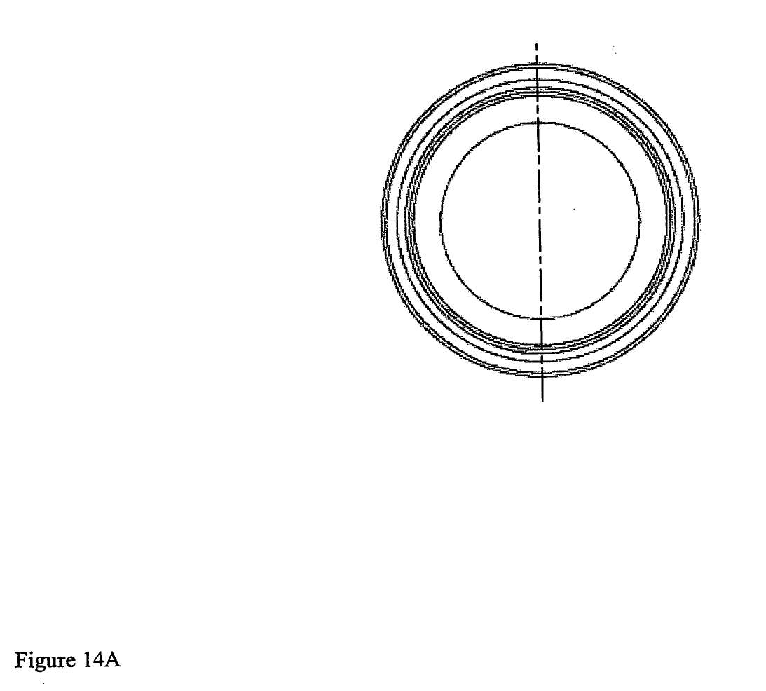

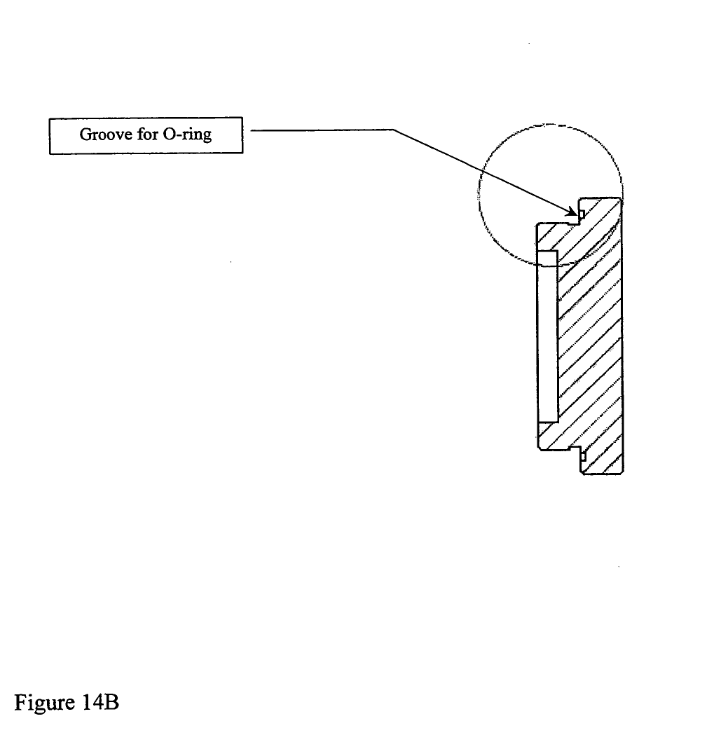

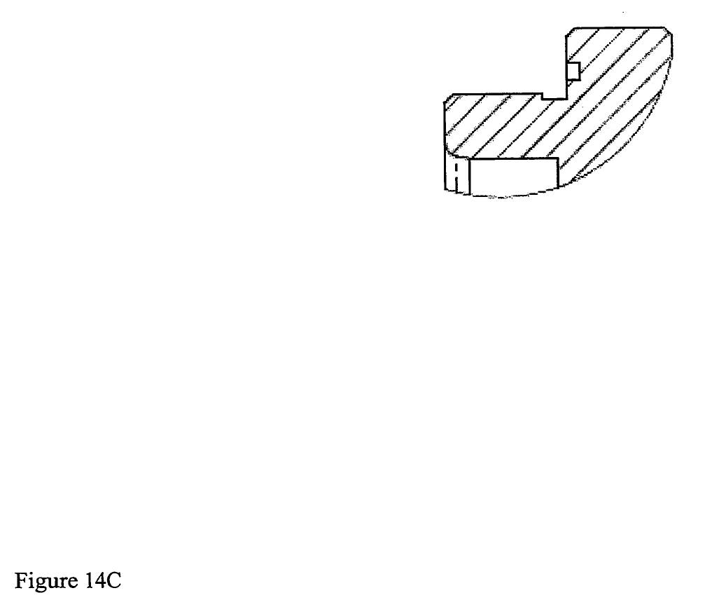

FIG. 11 is a three-dimensional bottom perspective view illustrating a removable cap (or lid) 5, which is designed for easier filter servicing. FIG. 12 is a front side view of the cap 5 in FIG. 11, illustrating the “O”-ring seal 24. The “O”-ring seal 24 securely seats the cap 5 onto the fuel system assembly body 3. FIG. 13 is a plan view of the cap in FIG. 11. FIG. 14 is a right side view of the cap 5, illustrating the “O”-ring seal 24 in place. FIG. 14A is a plan view of cap 5 which is bisected with an axis to illustrate the plane of the sectional view in FIG. 14B. FIG. 14B is a sectional view of cap 5 along the axis shown in FIG. 14A, illustrating the groove in the cap where the “O”-ring seal 24 fits. FIG. 14C is a sectional view of cap 5 along the circular section shown in FIG. 14B, illustrating the groove 25 for the “O”-ring and the area into which the fuel filter is seated.

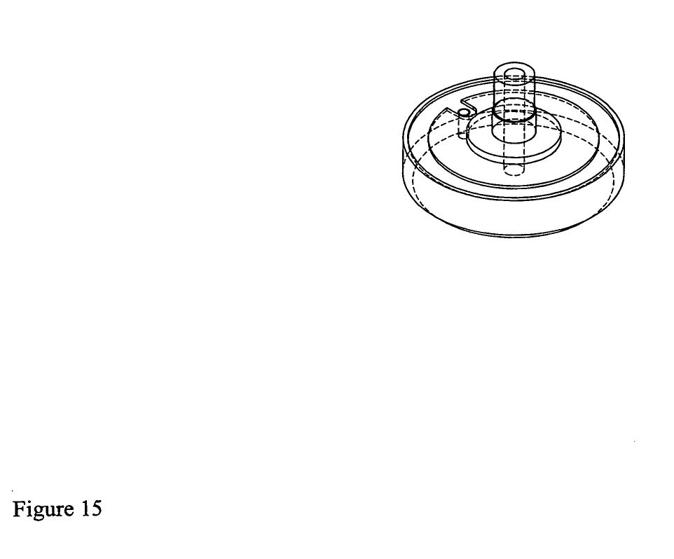

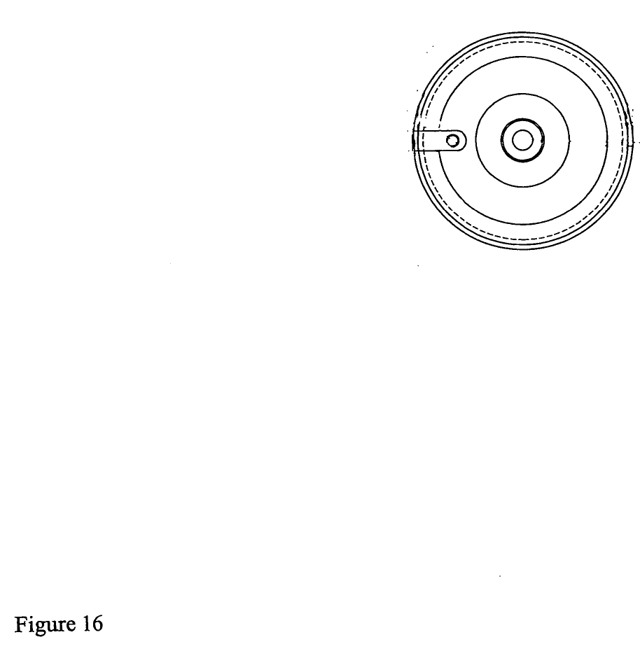

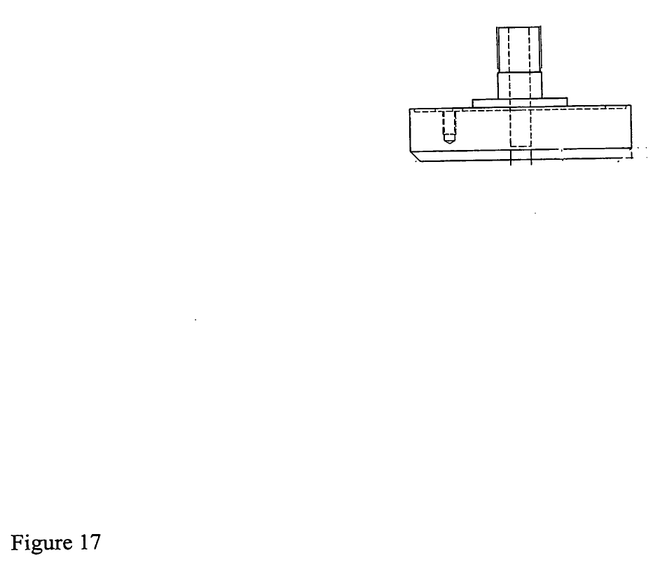

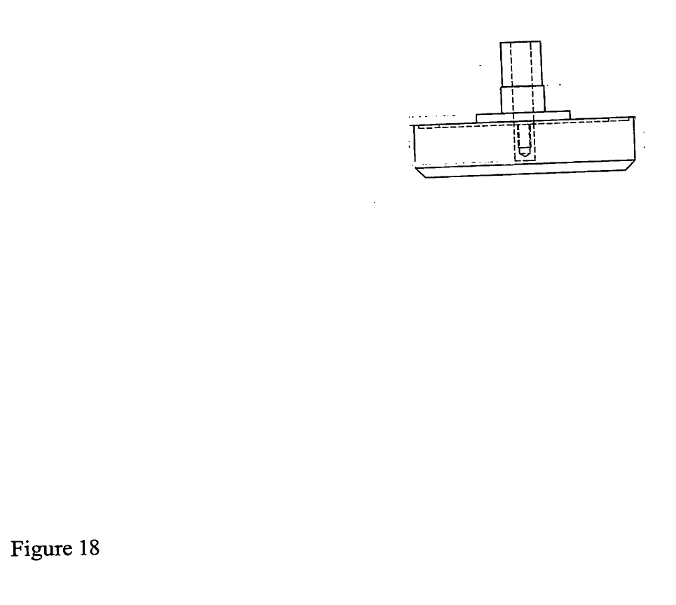

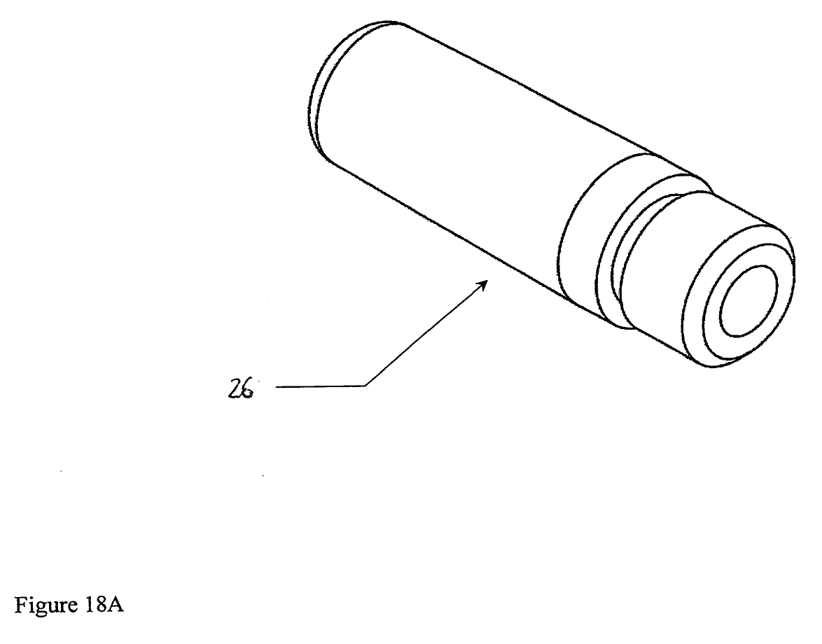

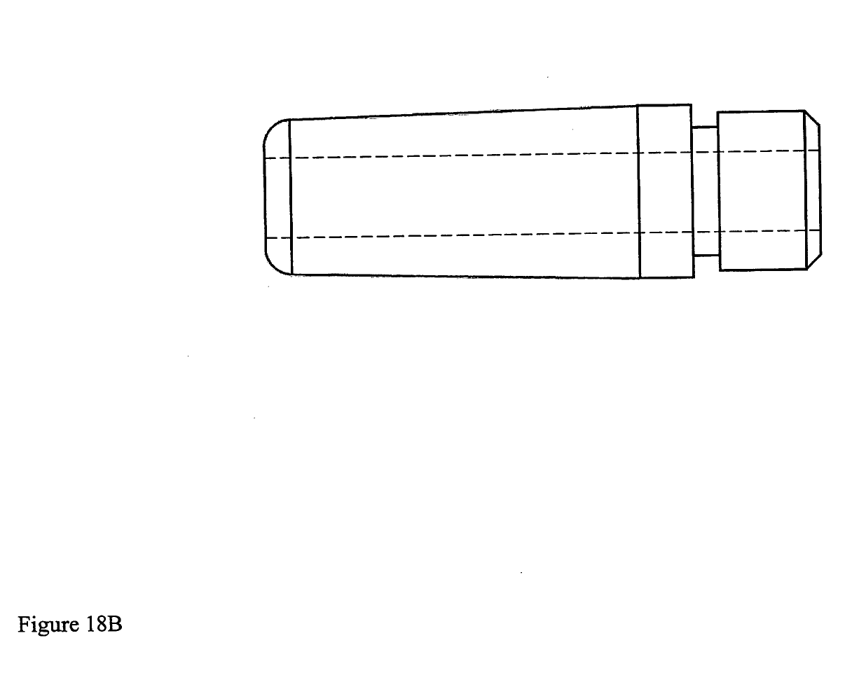

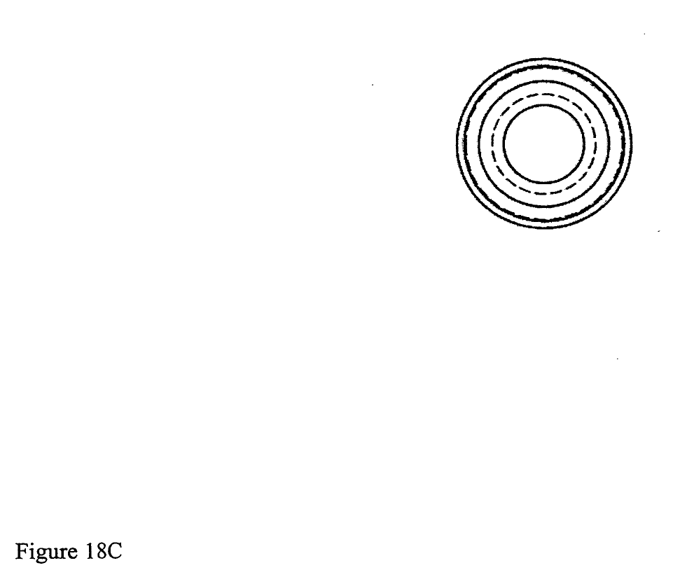

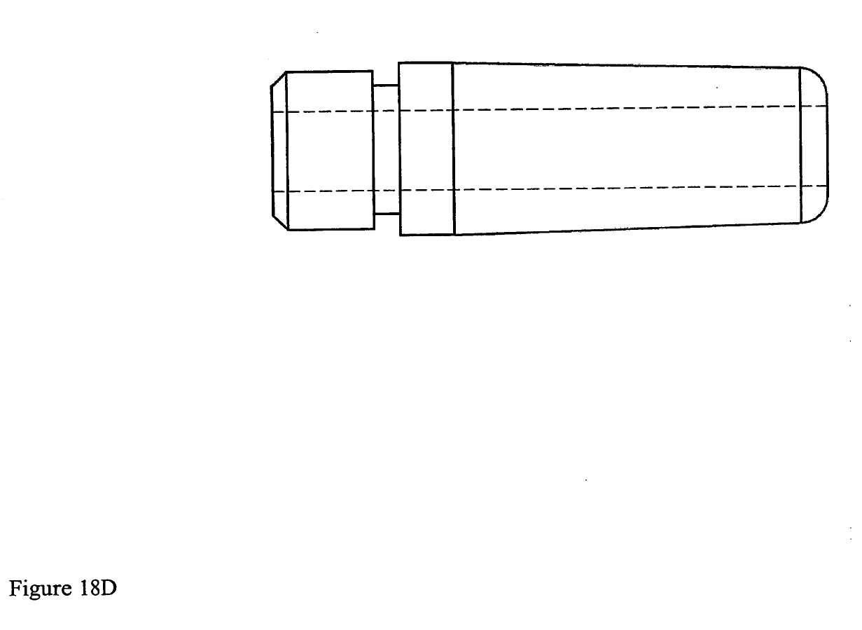

FIG. 15 is a top perspective view of a filter holder, which forms the base of the filter housing. The fuel filter 4 is held in place above the electric filter heater. FIG. 16 is a plan view of the filter holder shown in FIG. 15. FIG. 17 is a front side view of the filter holder shown in FIG. 15. FIG. 18 is a right side view of the filter holder shown in FIG. 15.

FIG. 18A is a front perspective view of the filter tube 26, which is seated inside the fuel system assembly body 3. FIG. 18B is a left side sectional view of the filter tube shown in FIG. 18A. FIG. 18C is an end view of the filter tube shown in FIG. 18A. FIG. 18D is a right side sectional view of the filter tube.

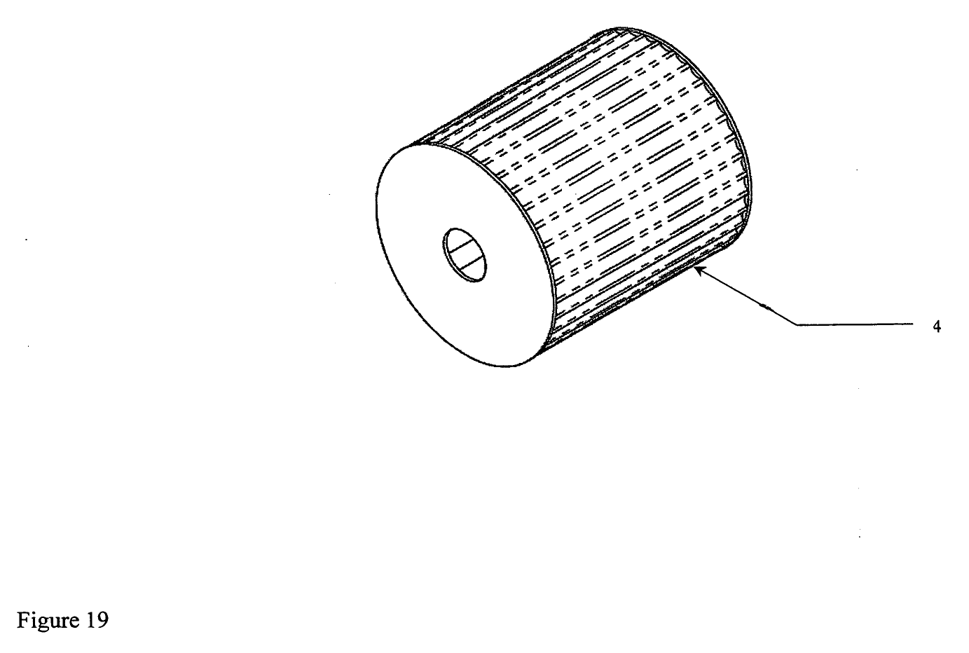

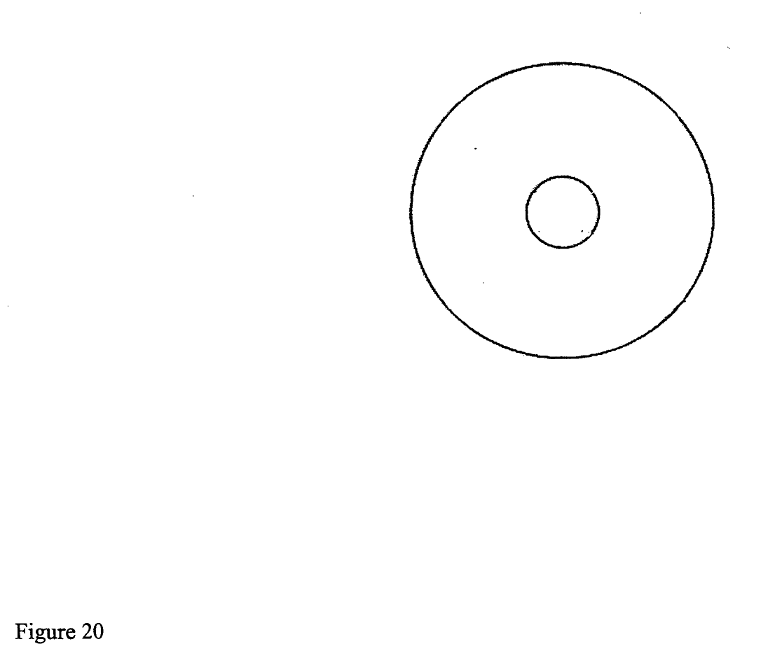

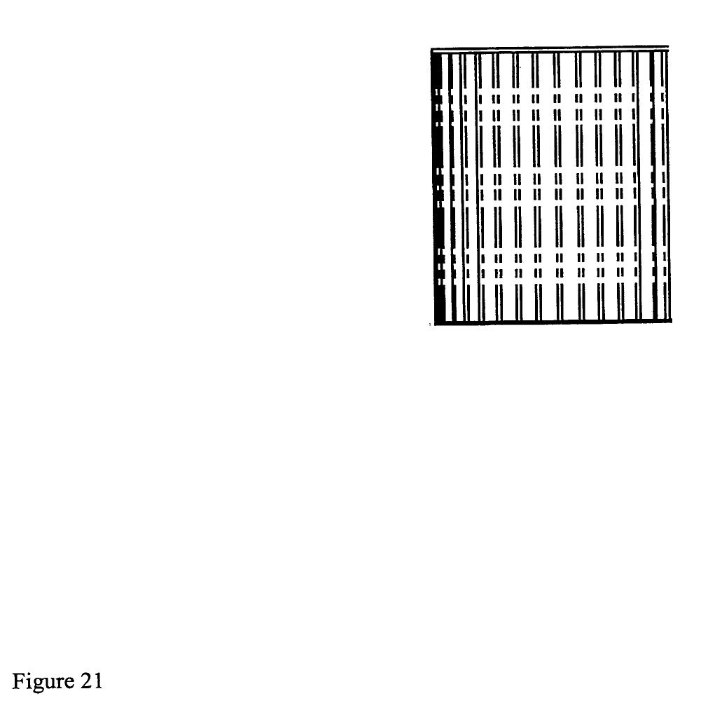

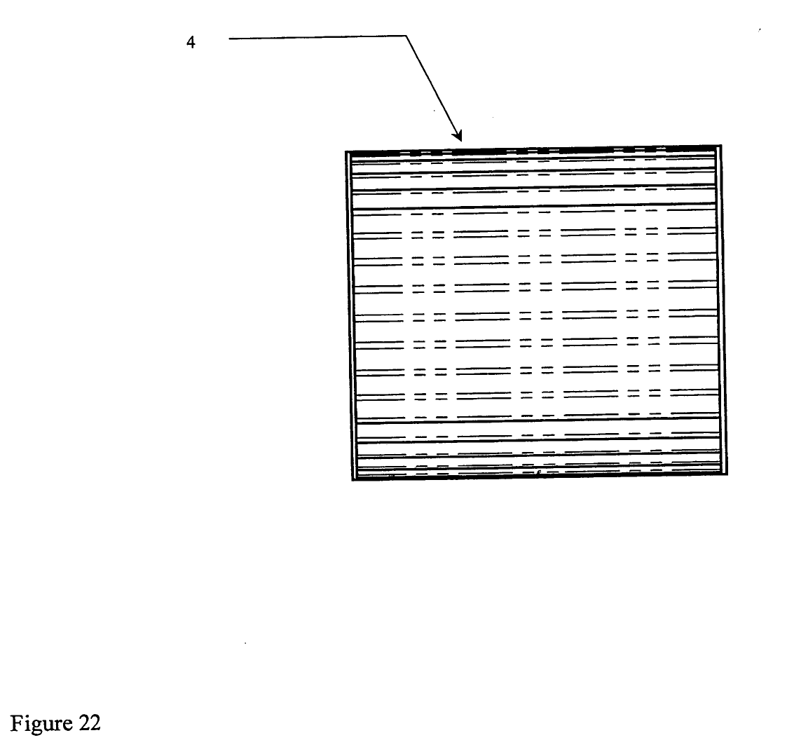

FIG. 19 is a front perspective view of the fuel filter 4. The filter media are stainless steel, and end caps are machined aluminum. Variance ranges for the fuel filter 4 are from fifty microns absolute and nominal to one micron absolute and nominal. FIG. 20 is a plan view of the fuel filter 4 shown in FIG. 19. FIG. 21 is a top side view of the fuel filter 4 shown in FIG. 19. FIG. 22 is a right side view of the fuel filter 4 shown in FIG. 19.

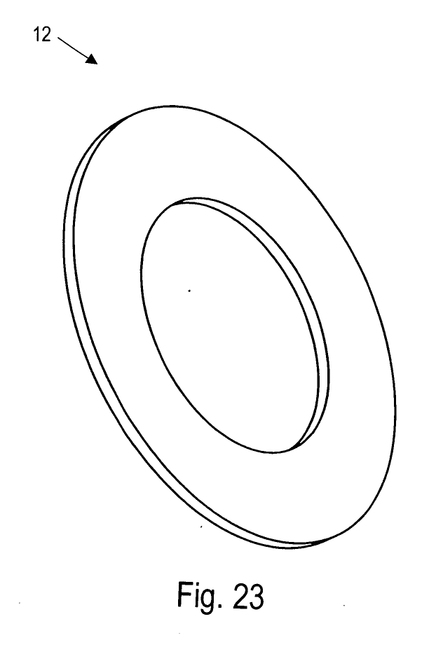

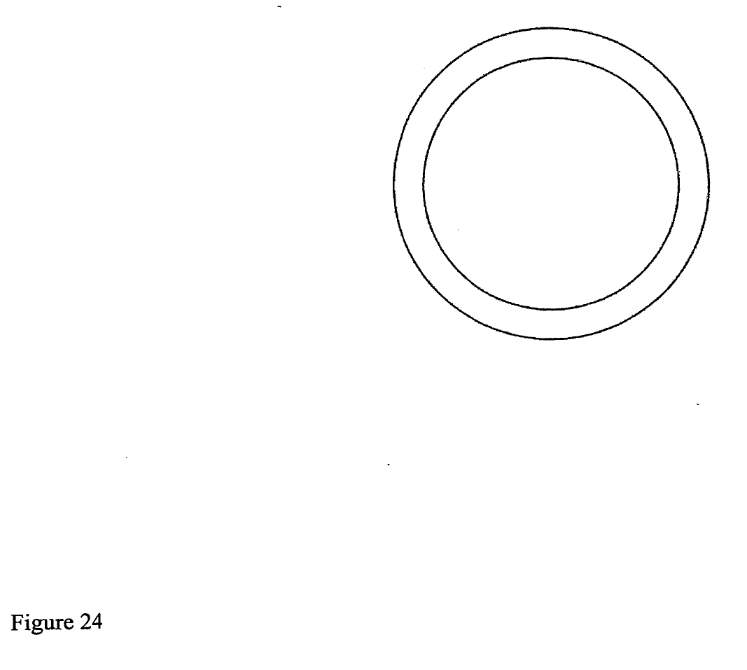

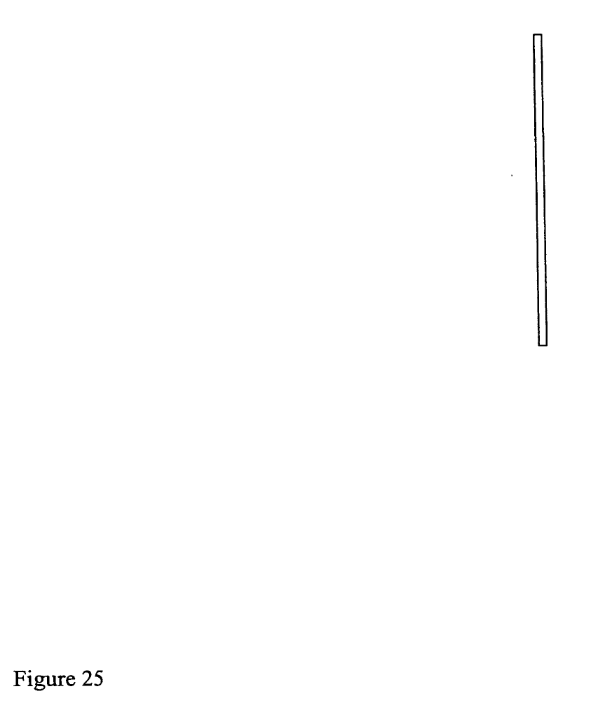

FIG. 23 is a front perspective view of a donut-shaped heater 12 which is a PTC (self-regulating) heater used in the fuel system assembly 1. FIG. 24 is a plan view of the donut-shaped heater 12 shown in FIG. 23. FIG. 25 is a right side view of the donut-shaped heater 12 shown in FIG. 23.

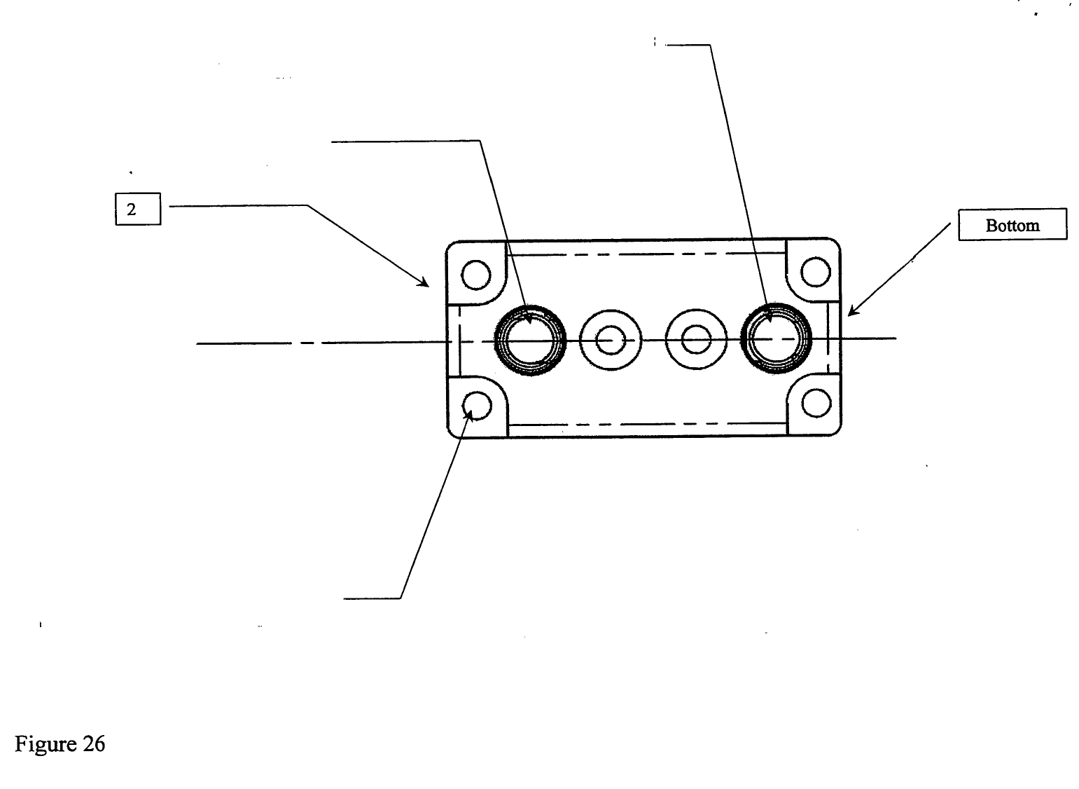

FIG. 26 is a plan view of the manifold 2 shown in FIG. 1 and FIG. 2, illustrating the access ports for Valve A and Valve B, and four holes for mounting bolts to attach the manifold 2 to the fuel system assembly body 3. Although this embodiment of the disclosure shows four holes for mounting bolts, alternative embodiments can use one or more mounting bolts to attach the manifold 2 to the fuel system assembly body 3 in this disclosure.

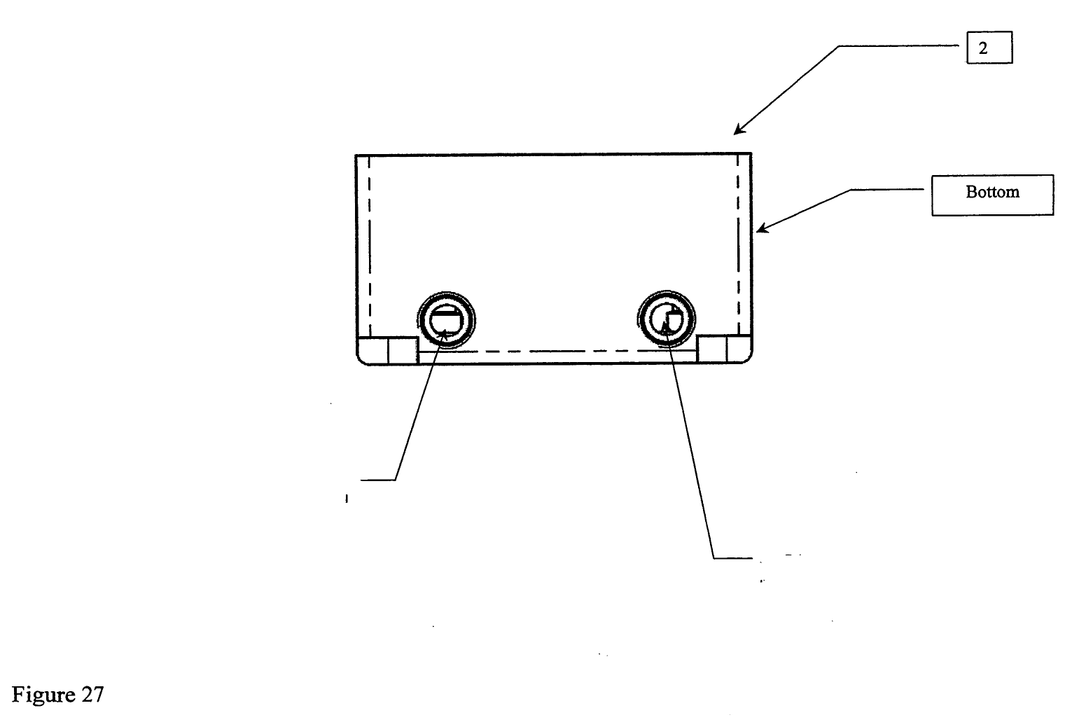

FIG. 27 is a left side view of the manifold 2 shown in FIG. 1 and FIG. 2, illustrating the port for Diesel In from Diesel Tank (revealing a section of Valve A inside manifold 2) and the port for the Diesel Return to Diesel Tank (revealing a section of Valve B inside manifold 2). The port for Diesel In is used for conventional petroleum diesel fuel intake, and a separate port, identified as Diesel Return, is used for conventional petroleum diesel fuel output.

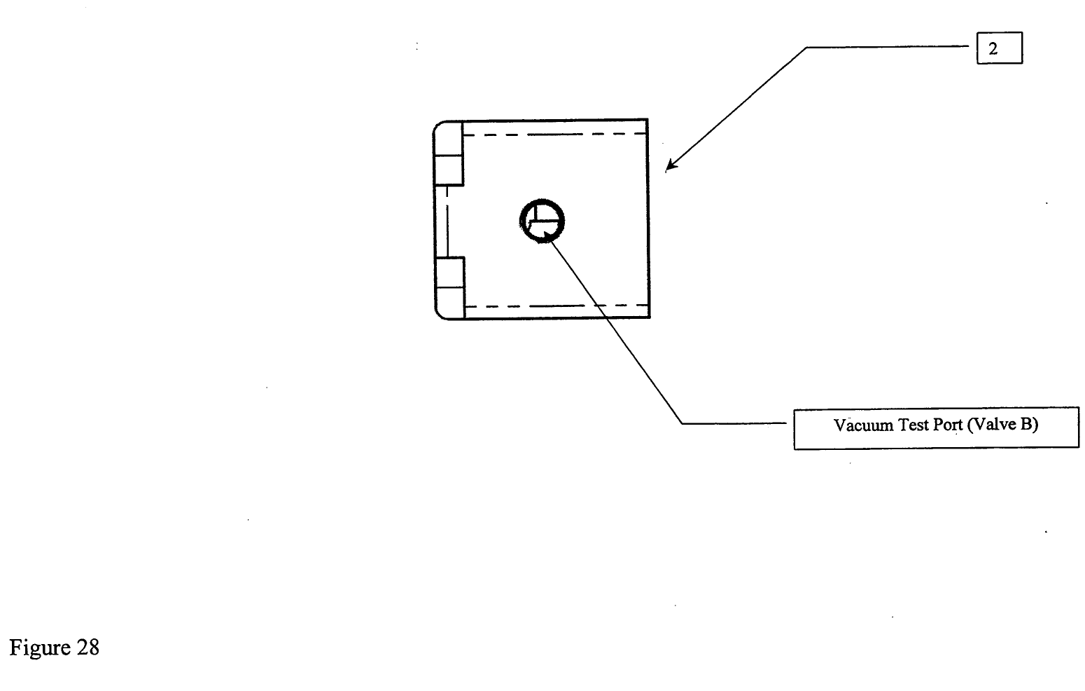

FIG. 28 is a rear side view of the manifold 2 shown in FIG. 1 and FIG. 2, specifically illustrating the Vacuum Test Port 27, revealing a section of Valve B 15 inside manifold 2. The vacuum test port 27, also called the vacuum boost sensor (or gauge) port, is used to monitor filter clogs or restrictions while either vegetable oil or conventional petroleum-based diesel fuel is flowing, so that proper service or maintenance may be performed on the filter before engine performance is compromised.

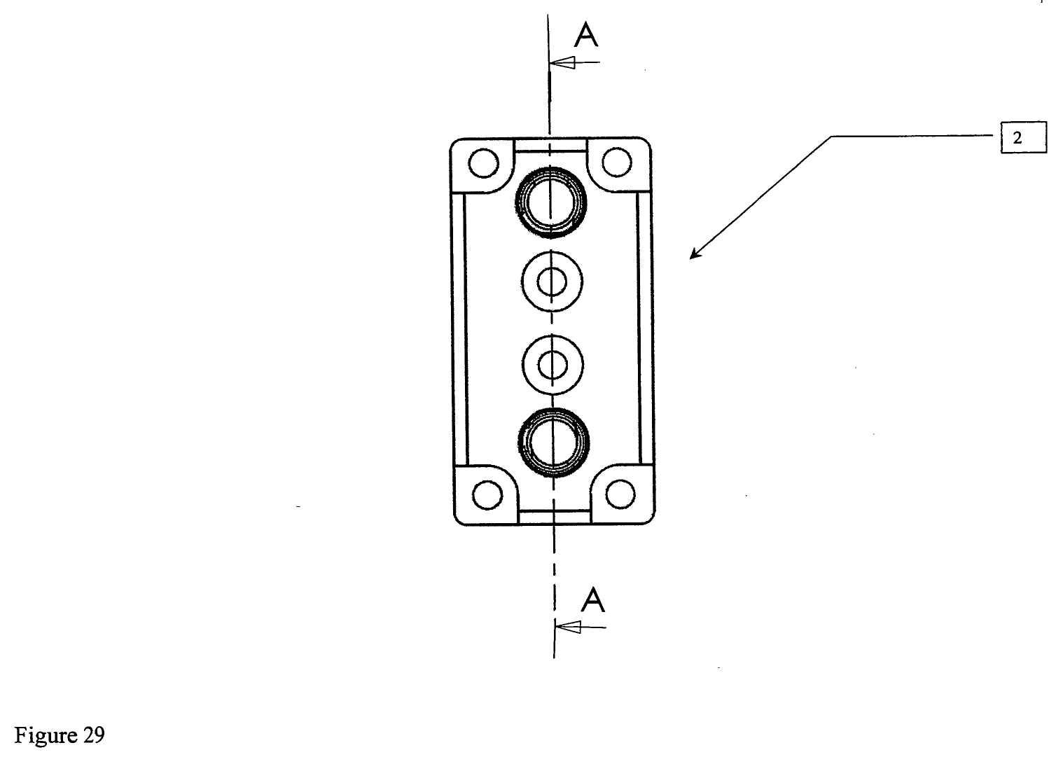

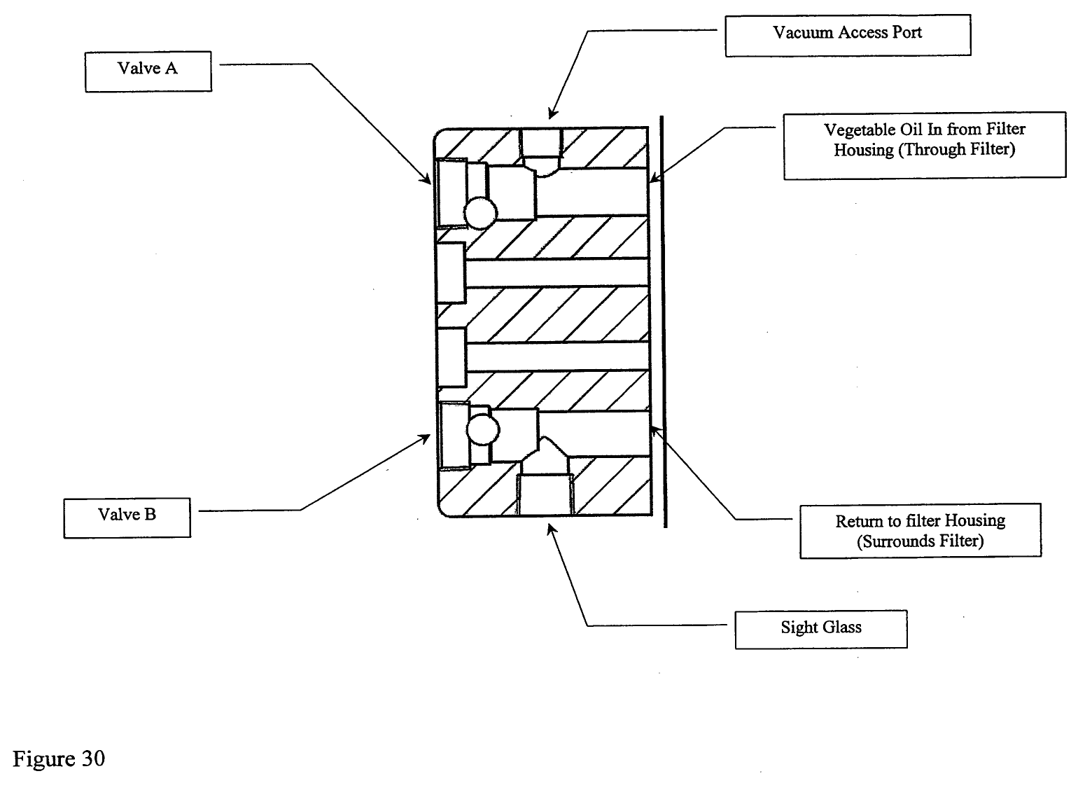

FIG. 29 is a plan view of manifold 2 in FIG. 1 and FIG. 2, illustrating axis A-A to be used as the plane along which the sectional view is taken for FIG. 30.

FIG. 30 is a right side sectional view along plane A-A of manifold 2, specifically illustrating the Sight Glass 28, the Vacuum Access Port 27, the Vegetable Oil In from Filter Housing (Through Filter), Valve A 14, and Valve B 15.

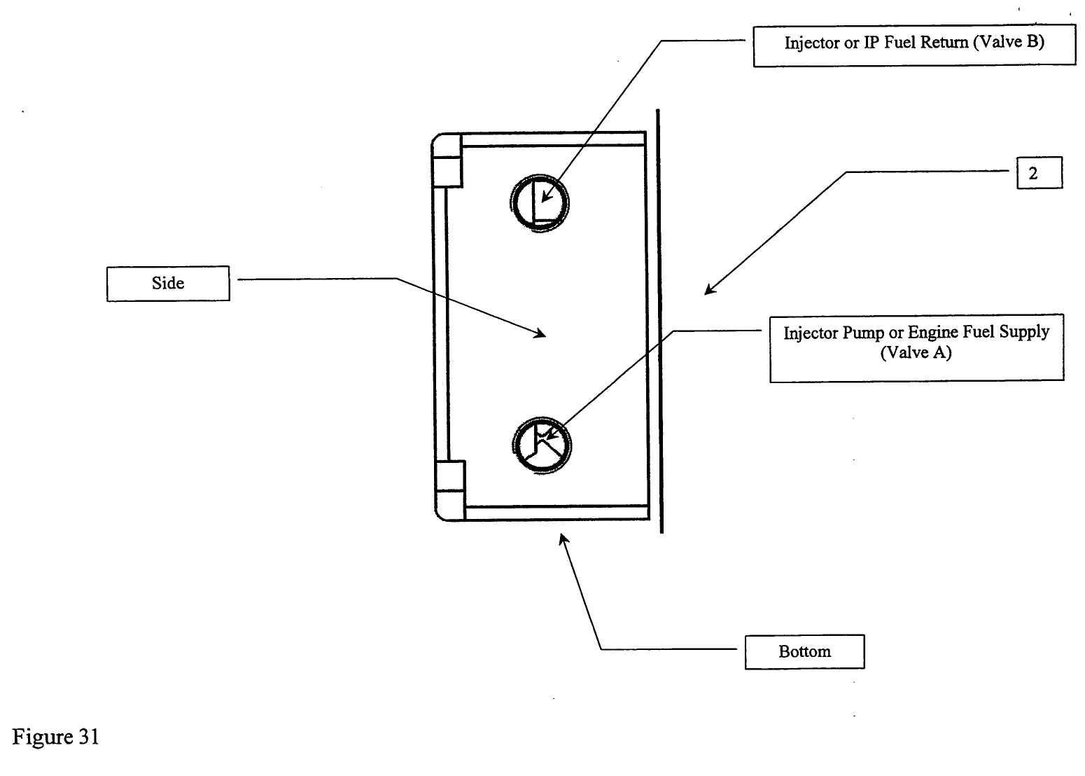

FIG. 31 is a left side view of manifold 2, illustrating the Injector Pump or Engine Fuel Supply (revealing a section of Valve A 14 inside the manifold) and the Injector or IP Fuel Return (revealing a section of Valve B 15 inside the manifold). The Injector Pump or Engine Fuel Supply is used as an injector (engine) pump feed, and a separate port, Injector or IP Fuel Return, is used as an injector pump return.

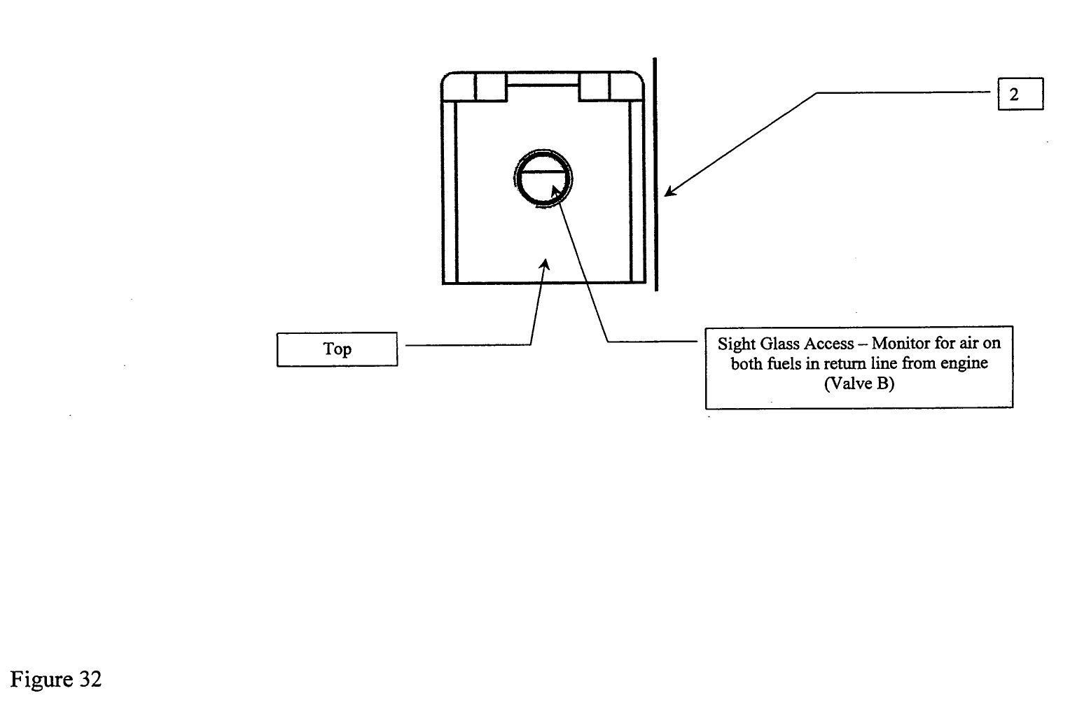

FIG. 32 is a front side view of the manifold 2 shown in FIG. 1 and FIG. 2, specifically illustrating the Sight Glass Access 25 (revealing a section of Valve B 15 inside manifold 2), which permits the operator to monitor for air on both fuels in return lines from the engine.

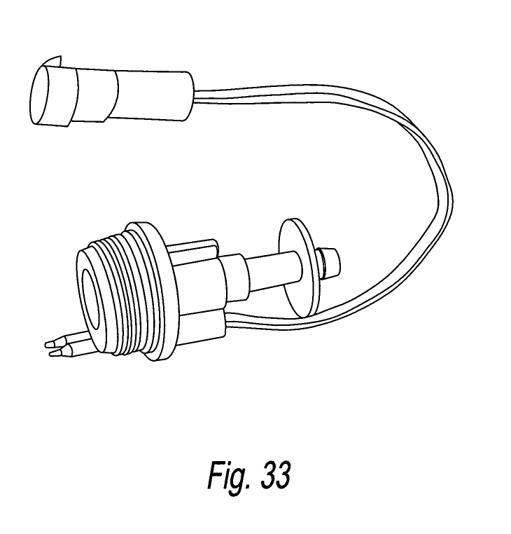

FIG. 33 is a front perspective view of a water sensor and drain valve, used to detect, separate and remove water contained in the vegetable oil fuel attached to the fuel system assembly body where indicated in FIG. 4.

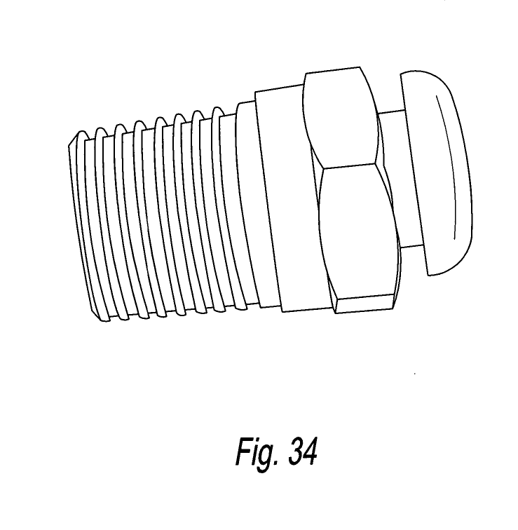

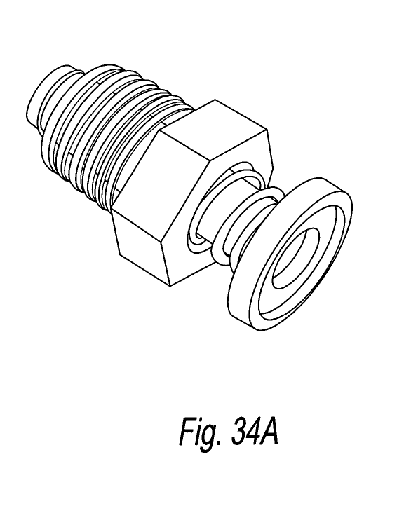

FIG. 34 is a front perspective view of a bleed valve 16 (also called bleeder valve) to be connected to the fuel system assembly body 3 at port 11. The bleed valve 16 serves to “bleed” air out of the vegetable oil fuel tank. FIG. 34A is a front perspective view of a bleed valve connected to the fuel system assembly body 3 at port 11, having the same function to “bleed” air out of the vegetable oil fuel tank.

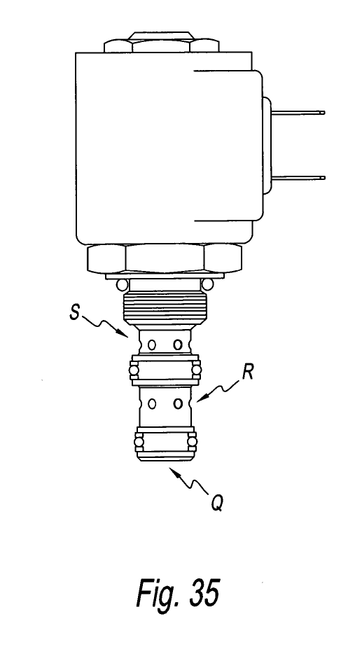

FIG. 35 is a diagram of a type of solenoid-operated, two-position, three-way, direct-acting, spool-type, screw-in hydraulic cartridge valve that can be used for the present disclosure. The manifold 2 of the present disclosure has ports for two cartridge solenoid valves, which are labeled in this embodiment of the disclosure as Valve A 14 and Valve B 15. When de-energized, the valve shown in FIG. 35 blocks flow of fuel at location 29, while allowing flow from location 30 to location 31. When energized, the spool shifts so that the valve provides flow of fuel from location 30 to location 29, while blocking flow at location 31. The same valve configuration is used for Valve A 14 and for Valve B 15 in the present embodiment of the disclosure, but the disclosure contemplates other types and configurations of valves to govern the flow of fuel.

More specifically, in this embodiment of the disclosure, Valve A 14 (FIG. 35) controls switching between the fuel source (feed) of vegetable oil or diesel oil to the engine injection system. Valve B 15 (FIG. 35) controls the return fuel flow, and has three (3) positions:
Position 1 allows diesel fuel to flow back to the diesel tank;
Position 2 allows vegetable oil to flow back to the loop; and
Position 3 allows diesel to flow back to the vegetable oil loop which creates a flush internally of the filter housing to prevent coagulating in the vegetable oil portion of the system at low temperatures.

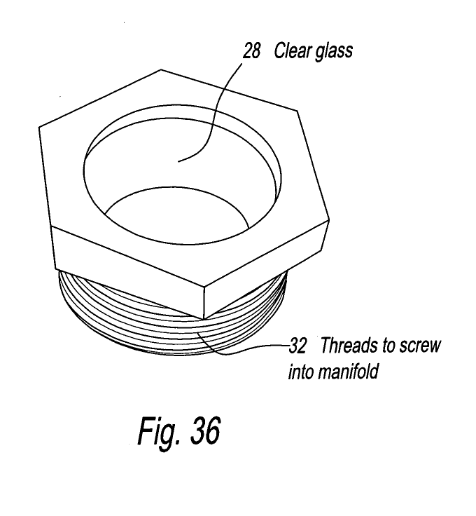

FIG. 36 is a front perspective view of a sight glass 28 (also called a sight window), with a threaded base 32 to screw into manifold 2 where shown in FIG. 30 and FIG. 32. The sight glass 28 is used for diagnostic testing, including monitoring for the presence of air in the fuel lines caused by cavitation in either the conventional petroleum diesel fuel system or the vegetable oil fuel system.

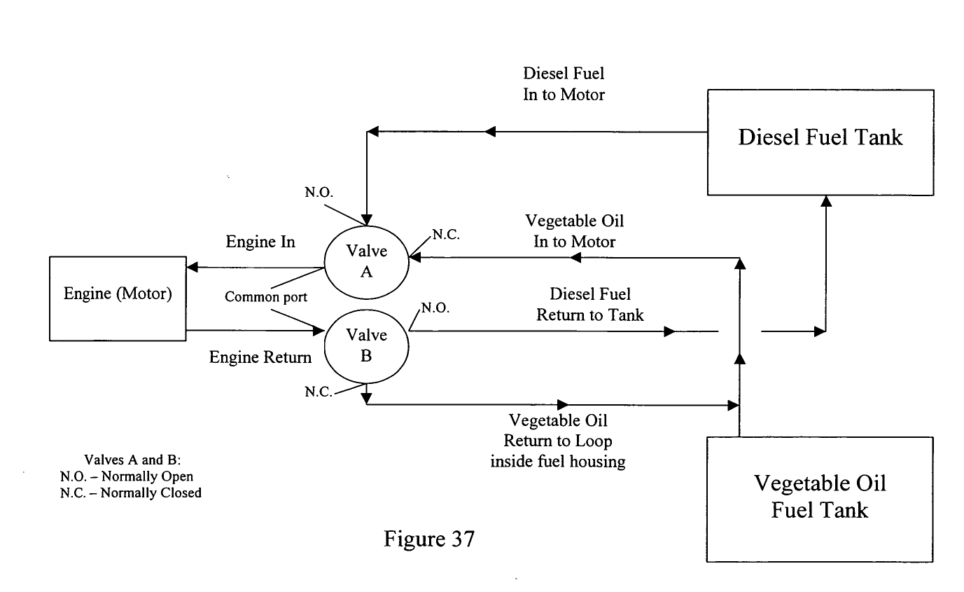

FIG. 37 is a schematic diagram illustrating the operation of the device for the present disclosure, the status of valves, and the flow of fuel in the diesel engine system.

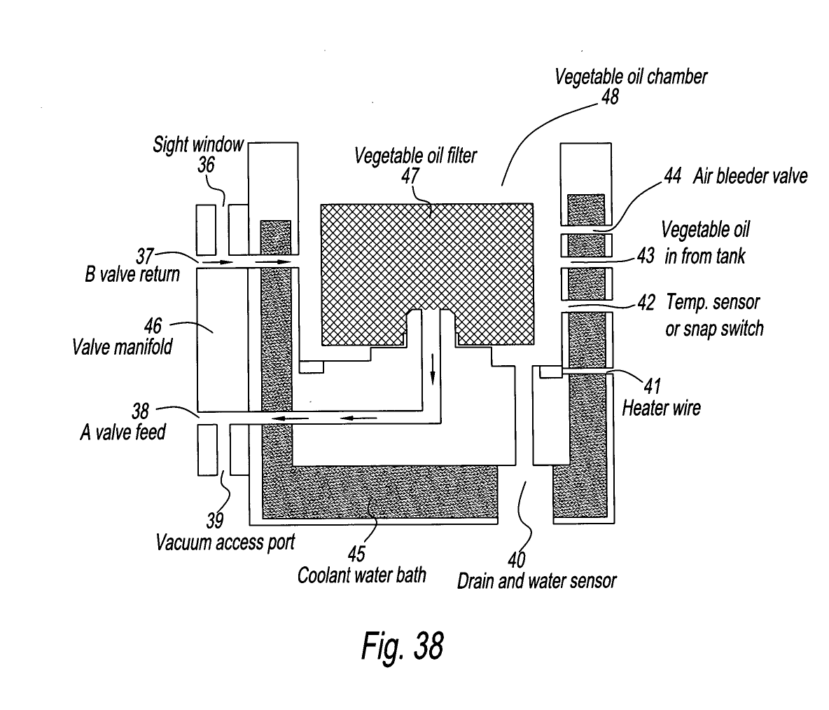

FIG. 38 is a schematic diagram of the fuel system assembly of the present disclosure, shown in a sectional view, illustrating the flow of oil as well as the fuel manifold, filter housing body, electric disc heater, fuel filter, coolant bath, sight window, Valve A and Valve B, the vacuum access port, the air bleed valve, the oil in port, the temperature sensor or snap switch ports, heater wire, and the water sensor and drain valve.

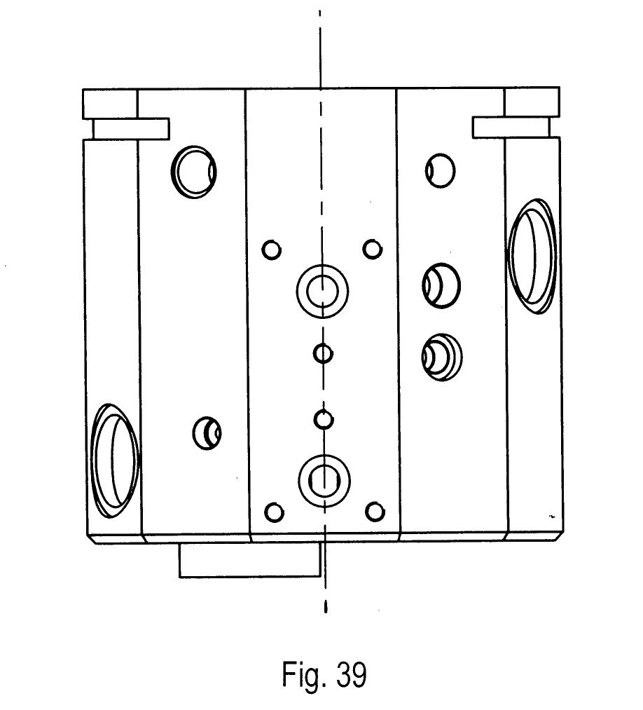

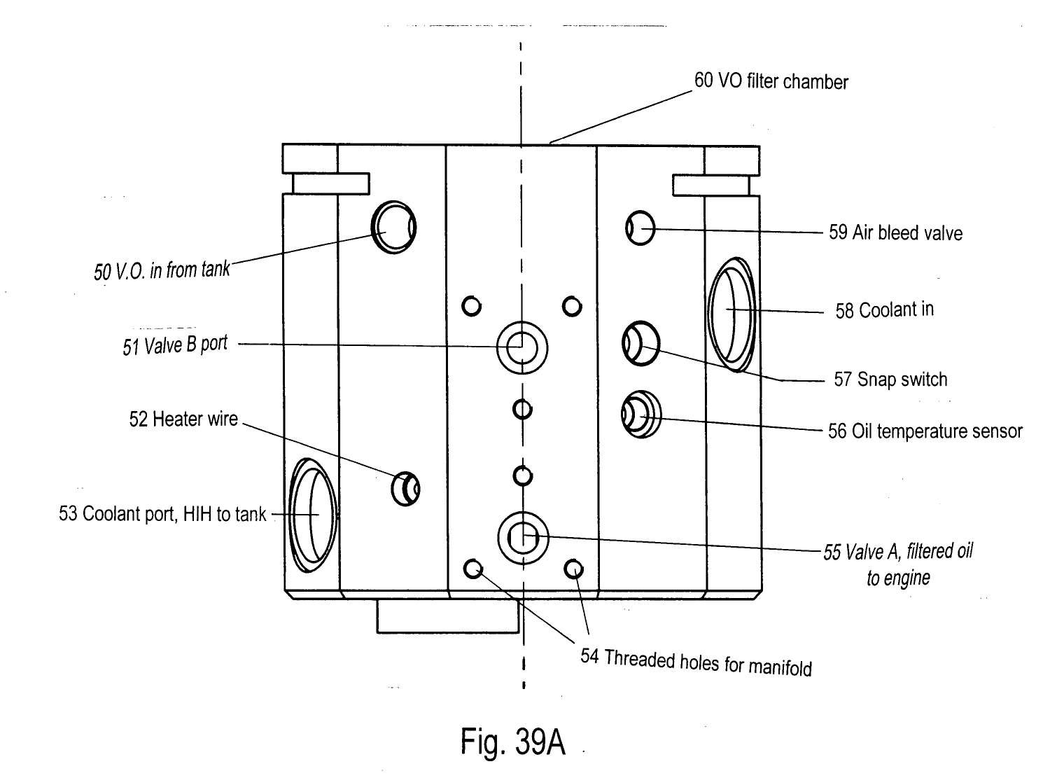

FIG. 39 is a front perspective view of the fuel system assembly body 3 (or cartridge). FIG. 39A is a front perspective view of the fuel system assembly body 3 (or cartridge) shown in FIG. 39, with labeled components.

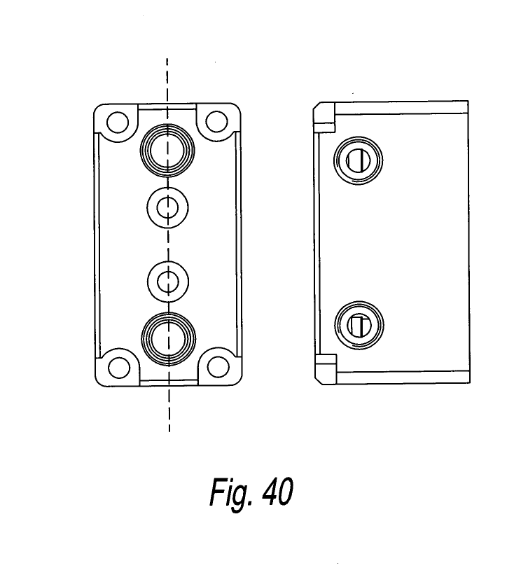

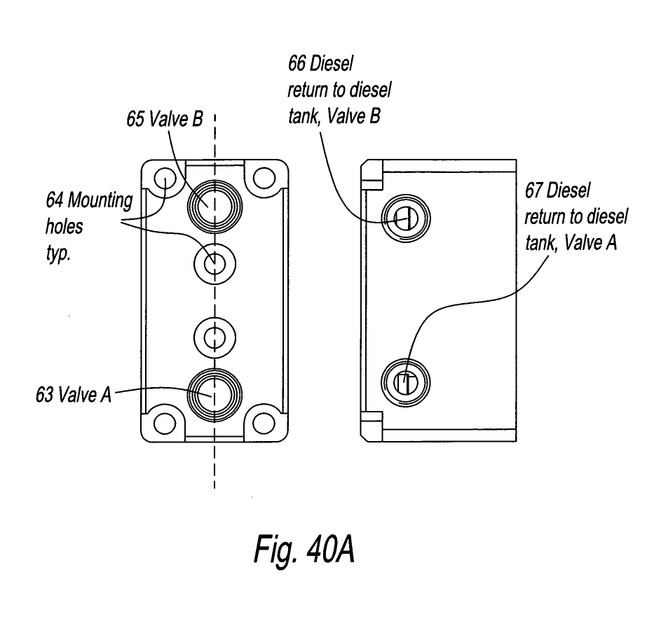

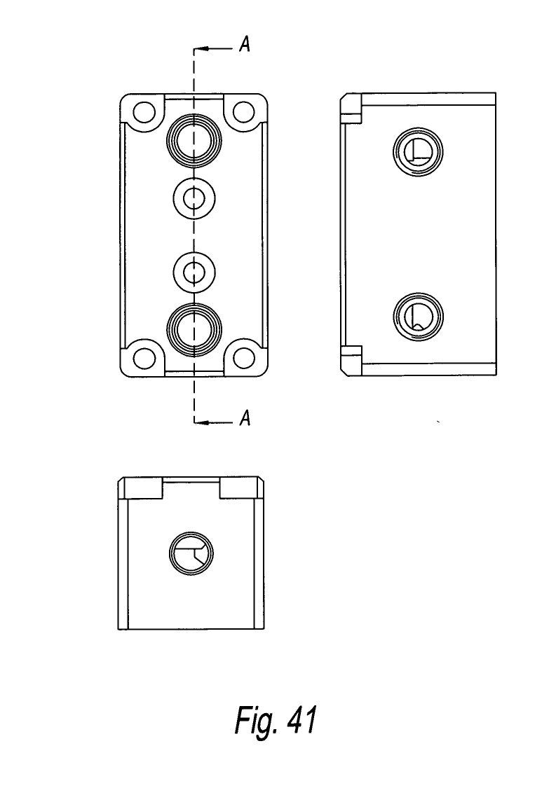

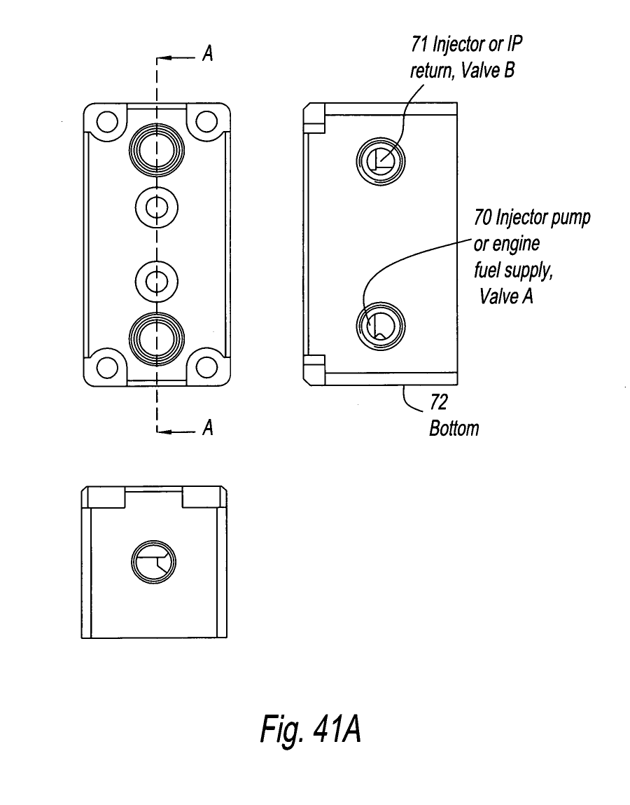

FIG. 40 is a left side view of the manifold 2. FIG. 40A is the manifold 2 shown in FIG. 40 with labeled components. FIG. 41 is a right side view of the manifold 2. FIG. 41A is the manifold 2 shown in FIG. 41 with labeled components.

When the diesel engine is operating with conventional petroleum diesel fuel (usually when the engine is started, or just before the engine is turned off), the diesel engine fuel system includes a fuel feed line or hose and a fuel return line or hose connected to the diesel tank. Once the fuel system switches over to operate using vegetable oil as fuel, the fuel system assembly as illustrated includes a fuel feed line or hose from the vegetable oil fuel tank and a looped return back to the vegetable oil fuel filter housing.

The switching between the types of fuels is accomplished by means of two valves, Valve A and Valve B, which are described in more detail in FIG. 35. Switching of fuel solenoids in manifold 2 permits one or more of the following operations: (1) supply of conventional petroleum-based diesel fuel to the engine and fuel return line to the diesel tank; (2) supply of vegetable oil to the engine and fuel return line in a closed loop to the filter body; and/or (3) supply of petroleum-based diesel fuel to the engine with fuel return line to the filter body to flush the fuel filter prior to shutdown of the engine.

As shown in FIG. 3, the fuel system assembly body 3 is surrounded on the sides and underneath with a coolant bath to maximize heat transfer from the coolant line to the vegetable oil and to the fuel filter cartridge 4. The heat transfer is sufficient to heat the vegetable oil and the fuel filter cartridge 4 to a temperature sufficiently high that the vegetable oil will burn efficiently in the combustion chamber.

An electric inline disc (donut shaped) heater 12 is illustrated in FIGS. 23, 24 and 25 to aid and accelerate the heating of the vegetable oil fuel and the fuel filter cartridge 4. One embodiment of the electric fuel heater is a Positive Temperature Coefficient (PTC) self-regulating electric heater made of a thermally-conductive metal that is heated by electricity from the engine or battery and surrounds the fuel line carrying the vegetable oil. Commercially-available electrical heating units for fuel systems using vegetable oils include VEGTHERM™ and VEGTHERM MEGA™ inline electric heaters (Neoteric Biofuels, Inc., Salmon Arm, British Columbia, Canada), which are generally 12 Volts and draw 20 Amperes, and can heat the vegetable oil to at least 160° F. Other electric fuel heaters that may be used in the present disclosure include the Arctic Fox Hotline™ Electric In-Line Fuel Heater (Arctic Fox, P.O. Box 309, 570 South 7th St., Delano, Minn., USA 55328) which are either 12 or 24 volt, and Racor in-line electric fuel heater No. 14257, which is 12 volt, 500 watt, rated at 35.7 Ampere nominal current draw, and Racor in-line electric fuel heater No. 14278, which is 12 volt, 300 watt, rated at 21.4 Ampere nominal current draw.

The fuel system assembly body 3 has a temperature sensor probe, located at port 9, which monitors vegetable oil temperature for computer control of the electric heater. The temperature sensor probe is also used to monitor fuel filter temperatures required for normal operation of the fuel system, which is described in more detail below.

A unique aspect of this design is the fuel system assembly body 3 which has a removable top loader cap 5 for ease of filter service. This allows the user to simply unscrew the lid for filter service rather than dealing with cumbersome spin-on type fuel filters. Also, this design allows for drain-off of debris at filter service and ease of bleeding air out of the system by simply running the engine in purge mode.

For those embodiments where a computer is not used for control of the heater function, the fuel system assembly body 3 has an access port 10 for a snap switch temperature sensor to control electric heater operation.

The fuel system assembly 1 of the present disclosure is designed to operate with vegetable oil heated to, or maintained at, a sufficient temperature to flow cleanly through the hoses from the oil tank to the fuel injection pump, through the fuel filter or filters, and into the combustion chamber. In the present disclosure, the fuel system assembly is operable at approximately 140° F. to 200° F. A vegetable oil temperature of at least 160° F. is optimal for combustion and for the fuel filters. For passage of the vegetable oil through the fuel lines, as well as in any fuel return lines for excess vegetable oil to be returned to the fuel tank, to minimize or prevent clogging of the return fuel line by solidified or crystallized vegetable oil, the vegetable oil does not need to achieve 160° F.; it needs-only be warm enough to flow freely through the fuel lines.

Vegetable oil used as fuel for diesel engines should be heated, and maintained at elevated temperatures, at all points outside of the fuel tank, to reduce viscosity and to pre-heat the vegetable oil to the temperature necessary for efficient injection and combustion in the cylinder. For the present embodiment of the disclosure, the vegetable oil may be heated by any of several ways described below, or by a combination of these heating methods.

The Hose-On-Hose (HOH) method of heating involves running heater hoses containing the engine's coolant fluid immediately adjacent to the fuel line carrying the vegetable oil, usually flowing in opposite directions, and wrapping the two hoses together with an insulating material. This method has the advantage that a leak in one hose will not lead to cross-contamination of the vegetable oil and coolant fluids, but is not as efficient for heat exchange as the Hose-In-Hose method described below.

The Hose-In-Hose (HIH) method of heating involves use of commonly available hoses where the fuel line carrying the vegetable oil is completely encompassed inside a larger-diameter hose carrying the hot engine coolant, which freely flows around the fuel line. The HIH method is more efficient for heat exchange than the HOH method, and the most effective in extremely cold temperatures. However, the HIH method has the drawbacks of requiring additional compression fittings, and holds a greater risk that the vegetable oil and coolant fluid would mix in the unlikely event of a leak in the fuel line.

Electric heating units are another heating method to pre-heat vegetable oil in the fuel lines, and to heat fuel filters. A typical inline electrical heating unit is a lengthy piece of highly temperature-conductive metal that is heated by electricity from the engine or battery and surrounds the fuel line carrying the vegetable oil. Commercially-available electrical heating units for fuel systems using vegetable oils include VEGTHERM™ and VEGTHERM MEGA™ inline electric heaters (Neoteric Biofuels, Inc., Salmon Arm, British Columbia, Canada). Other commercially available electric fuel heaters that may be used in the present disclosure include the Arctic Fox Hotline™ Electric In-Line Fuel Heater (Arctic Fox, P.O. Box 309, 570 South 7th St., Delano, Minn., USA 55328) which are either 12 or 24 volt, and Racor in-line electric fuel heater No. 14257, which is 12 volt, 500 watt, rated at 35.7 Ampere nominal current draw, and Racor in-line electric fuel heater No. 14278, which is 12 volt, 300 watt, rated at 21.4 Ampere nominal current draw. Electrical inline heaters are generally 12 Volts-20 Amperes, and can heat the vegetable oil to at least 160° F. Use of electric heaters avoids a drawback of HIH systems, which is potential contamination of the vegetable oil by coolant system fluids in the event of a leak in the vegetable oil fuel line, but electric heaters draw significant amperage from the battery and thus should not be used unless the engine is running and properly charging the vehicle's electrical system.

Even if vegetable oil is preheated to a temperature that permits unimpeded flow through the fuel lines (and through return fuel lines for excess vegetable oil leading away from the combustion chamber), it may still require additional heat energy to be atomized for efficient combustion in the combustion chamber. Electrically-heated fuel filters may achieve oil temperatures of approximately 110-120° F., and coolant-heated fuel filters may achieve somewhat higher temperatures, but heating the vegetable oil to the optimal 160° F. requires heat exchange over a longer distance by either electrical (such as 12 volt power) or coolant systems. One of the ways to achieve this is similar in function to the Hose-In-Hose (HIH) method described above to heat the fuel lines, where a coil of tubes made from a highly conductive metal containing coolant circulating around the fuel line, so that the temperature of the fuel leaving the coil of tubes is close to the temperature of the coolant in the engine, which is greater than 160° F. when the engine is warmed to operating temperature. If the distance from the heat exchanger to the injection pump is small, the vegetable oil should be within the range of acceptable combustion temperatures. Standard commercially available heat exchangers are commonly used in other systems. One example of a commercially-available heat exchanger adapted for vegetable oil fuel systems is the FRYHE050™ (from Frybrid, LLC, Seattle, Wash., USA). An embodiment of the present disclosure uses an aluminum vegetable oil fuel line which is encompassed by a larger-diameter hose with coolant fluid, in an attempt to heat the vegetable oil to the requisite temperatures. The fuel line carrying the vegetable oil may be made of any metal or material which is thermally conductive that will not react or be chemically attacked by the engine coolant fluid or by the vegetable oil.

The actual temperature of the vegetable oil may be monitored by the user by tapping an electrical fuel temperature sensor into the fuel line at a position just before the injection pump, which is connected to a temperature gauge. The temperature gauge may be mounted inside the vehicle (typically on the dashboard), or may be mounted elsewhere.

Vegetable oil used as fuel requires additional heat energy to be atomized for the combustion chamber. Most electrically-heated fuel filters can achieve oil temperatures of approximately 65° F.-85° F., and coolant-heated fuel filters can achieve temperatures in the range of 10° F.-120° F. depending on how far they are mounted from the heat source. However, heating the vegetable oil to at least 160° F. for efficient combustion requires heat exchange over a longer distance when using either an electric inline heater or one of the HIH or HOH methods described above using the engine's cooling system. The extra heat may be supplied to the vegetable oil using a heat exchanger that is similar in concept to the Hose-In-Hose (HIH) method described above to heat the fuel lines, except that the surface area is greatly increased by using a coil of tubes made from a highly conductive metal which contain engine coolant fluid that is circulating around the fuel line. The temperature of the vegetable oil leaving the coil of tubes by this heating method approaches the temperature of the circulating coolant fluid, which is generally well above 160° F. when the diesel engine is warmed to operating temperature. If the distance from the heat exchanger to the injection pump is small, the temperature of the vegetable oil should be within the range of acceptable combustion temperatures; i.e., approximately 160° F. or greater. A commercially-available heat exchanger for this purpose is the FRYHE050™ (from Frybrid, LLC, Seattle, Wash., USA).

In practice, the “all-in-one” combination fuel filter and fuel heating system assembly may be used to operate diesel engines using vegetable oil as fuel in vehicles using either a “two-tank” or “single-tank” apparatus. When used as part of the “two-tank” apparatus, one fuel tank holds the vegetable oil and the second fuel tank holds conventional petroleum-based diesel fuel (or, alternatively, a vegetable oil-derived biodiesel fuel). The diesel engine is started using fuel from the tank holding the petroleum-based diesel fuel, and is operated on that fuel for sufficient time until the vegetable oil in the secondary fuel system (which includes oil being held in the second tank as well as in the fuel filter and in the fuel lines) is pre-heated by either an electrical heater or the engine's own cooling system, or a combination of both heating methods. When the vegetable oil in the filter reaches the approximate temperatures of 70° C.-80° C. (160° F.-180° F.), the fuel source is switched to vegetable oil in the fuel tank. Although the temperature of the vegetable oil may not necessarily reach 70° C.-80° C. (160° F.-180° F.) inside the tank, it will likely be near this temperature after several minutes. As the vegetable oil passes through the heated fuel line toward the fuel filter, the vegetable oil will absorb additional heat. After the vegetable oil passes through the heated fuel lines, the vegetable oil will undergo a final “double” heating process where the vegetable oil will obtain additional heat from the heated fuel filter of the disclosure by both hot coolant and by the electric heater. At this point, the vegetable oil will reach the minimum optimal temperatures.

Moments before the diesel engine is shut down, the fuel source is switched back to the conventional petroleum-based fuel to purge the fuel lines of vegetable oil and to clear the fuel filters in preparation for the next cold start-up.

Alternatively, the fuel system assembly of the present disclosure may be used to operate diesel engines using vegetable oil as fuel with a “single-tank” fuel system. Single-tank systems are analogous to the two-tank system described herein except single-tank systems use specially-made injector nozzles, increased injection pressure, and stronger glow-plugs, in addition to fuel pre-heating.

The present disclosure may also be used in conjunction with biodiesel fuel, which is a type of diesel fuel that is chemically derived from vegetable oil or animal fat. Biodiesel fuel is vegetable oil or animal fat that has been chemically transformed by reacting the oil or fat with an alcohol, producing a “biodiesel” product having sufficiently-reduced viscosity to enable it to be directly substituted as neat fuel or as an oxygenate additive for use in diesel engines. Examples of common chemical processes used to produce biodiesel fuels from vegetable oils include transesterification, pyrolysis, micro-emulsion, and thermal depolymerization. As an example, transesterification of a vegetable oil intended for use as diesel fuel is accomplished by reacting the vegetable oil with an alcohol in the presence of a catalyst, thereby neutralizing the free fatty acids and creating an alcohol ester, which then possesses the proper viscosity to be used as diesel fuel after further processing to remove byproducts (such as glycerin) and impurities. As an example, soybean oil may be subjected to transesterification by reacting the soybean oil with a solution of methanol (CH₃OH) and sodium hydroxide (NaOH), thereby yielding the biodiesel product (in the form of a methyl ester) and the reaction byproduct glycerin, which must be separated from the biodiesel product, usually by allowing the solution to settle in a settling tank.

As used herein, the terms “all-in-one,” “unitary,” and “single unit,” are used interchangeably to indicate that all of the component parts of the device are joined to form a single, discrete unit.

The present disclosure includes a method of using a fuel device for operating a motorized vehicle that uses a vegetable oil comprising: drawing the vegetable oil from a fuel tank through conduits into a fuel system assembly body; heating the vegetable oil within the fuel assembly body; heating a filter within the fuel assembly body; filtering the heated vegetable oil through the heated filter to remove impurities from the vegetable oil; and feeding the filtered vegetable oil through a valve and a manifold to an engine in the motorized vehicle, wherein the fuel system assembly body, filter, heater, valve and manifold are joined to form a single, all-in-one unit.

The “all-in-one” fuel system assembly of the present disclosure provides an advantageous method to use vegetable oil as fuel for diesel engine systems for motor vehicles such as automobiles, trucks, boats, and agricultural machines such as tractors, while preventing or overcoming the common problems of insufficient fuel temperature or fuel filter waxing/clogging found in previous fuel systems using vegetable oil. However, the “all-in-one” fuel system assembly of the present disclosure can be readily adapted to use vegetable oil as fuel for smaller diesel engine systems used in chain saws, mopeds, and jet skis, as well as for large diesel engine systems such as train locomotives, large ships and electrical power-generating facilities.

From a practical standpoint, the vehicle is started using diesel fuel. Once the engine is started, the electric heater begins to warm the vegetable oil within the filter housing. At the same time, the coolant is heating the vegetable oil within the housing by surrounding the filter. Once sufficient temperature is reached, a switch (or a computer control) switches the fuel source from diesel to vegetable oil. In this all-in-one design, all required components (including the fuel filter, fuel switching valves, electric filter heater, coolant bath, viewing window, temperature and vacuum sensors) are built into the filter housing.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the appended claims.

What is claimed is:

1. A fuel device for a motorized vehicle that uses a vegetable oil comprising:
a fuel system assembly body having a filter that is heated; and
a heater operatively connected to the filter,
wherein the fuel system assembly body receives the vegetable oil so that the heater heats the filtered vegetable oil for operational use in the vehicle and so that the filter removes impurities in the vegetable oil.

2. The fuel device according to claim 1, wherein the filter is positioned inside of the fuel system assembly body.

3. The fuel device according to claim 2, wherein the filter is positioned in a filter housing.

4. The fuel device according to claim 3, wherein the filter housing is double-walled.

5. The fuel device according to claim 4, wherein the double-walled filter housing has a first wall and a second wall that are separated to provide a hollow chamber therebetween.

6. The fuel device according to claim 5, wherein the fuel system assembly body is connected to an engine and an engine coolant system of the motorized vehicle.

7. The fuel device according to claim 6, wherein the engine coolant system provides engine coolant that flows into the hollow chamber of the filter housing between the first wall and the second wall.

8. The fuel device according to claim 1, wherein the fuel system assembly body has a cap that is removable to permit access to the filter for filter service.

9. The fuel device according to claim 1, wherein the filter is made of a material selected from the group of stainless steel, paper, other filter media, and any combinations thereof.

10. The fuel device according to claim 1, wherein the heater is positioned in the fuel system assembly body.

11. The fuel device according to claim 10, wherein the heater is a heat exchanger selected from the group consisting of electric heater, electric inline heater, Hose-On-Hose, Hose-In-Hose, and any combinations thereof.

12. The fuel device according to claim 11, wherein the heater is controlled by a computer, a microprocessor, and/or a temperature sensor.

13. The fuel device according to claim 1, wherein the fuel device is connected to a fuel tank containing a vegetable oil.

14. The fuel device according to claim 13, wherein one or more conduits connect the fuel tank containing the vegetable oil to the fuel system assembly body.

15. The fuel device according to claim 14, wherein the one or more conduits are heated by a heater that is a heat exchanger selected from the group consisting of electric heater, electric inline heater, Hose-On-Hose, Hose-In-Hose, and combinations thereof.

16. The fuel device according to claim 1, further comprising a manifold.

17. The fuel device according to claim 1, further comprising a plurality of valves.

18. The fuel device according to claim 17, wherein the plurality of valves operatively connect the fuel system assembly body to an engine so that vegetable oil is permitted to flow to the engine.

19. The fuel device according to claim 1, wherein the fuel device is a single unit.

20. A method of using a fuel device for operating a motorized vehicle that uses a vegetable oil comprising:
drawing the vegetable oil from a fuel tank through conduits into a fuel system assembly body;
heating the vegetable oil within the fuel assembly body;
heating a filter within the fuel assembly body;
filtering the heated vegetable oil through the heated filter to remove impurities from the vegetable oil; and
feeding the filtered vegetable oil through a valve and a manifold to an engine in the motorized vehicle;
wherein the fuel system assembly body, filter, heater, valve and manifold are joined to form a single unit.
